(19) United States
(12) Patent Application Publication
(10) Pub. No.: US 2019/0392368 A1
(43) Pub. Date: Dec. 26, 2019

(54) System and Method for Scheduling Multiple Modes of Transport

(71) Applicant: Mitsubishi Electric Research Laboratories, Inc., Cambridge, MA (US)

(72) Inventors: Arvind Raghunathan, Medford, MA (US); David Bergman, Wethersfield, CT (US); Hiroyuki Hashimoto, Cambridge, MA (US); Shingo Kobori, Tokyo (JP)

(73) Assignees: Mitsubishi Electric Research Laboratories, Inc., Cambridge, MA (US); Mitsubishi Electric Corporation, Tokyo (JP)

(21) Appl. No.: 16/211,311

(22) Filed: Dec. 6, 2018

Related U.S. Application Data
(60) Provisional application No. 62/689,064, filed on Jun. 23, 2018.

(51) Int. Cl. G06Q 10/06; G06F 17/12; G06Q 10/02

(52) U.S. Cl. CPC G06Q 10/063116; G06Q 10/02; G06F 17/12

(57) ABSTRACT

A system for assigning commuter vehicles (CVs) in a multi-modal transportation network having the CVs and fixed schedule vehicles to passengers is disclosed. The system receives itinerary requests from the passengers, wherein the itinerary requests of the passengers include initial locations, target locations, departure times from the initial locations, and arrival time windows including deadlines at the target locations. The system includes a memory to store computer executable programs including a grouping program, a route-search program, an operation route map program of the CVs, and a commuter assigning program, and a processor to perform steps of the programs in connection with the memory, wherein the steps include grouping the passengers into a set of groups, assigning the CVs to the groups by performing the commuter assigning program and generating assignment information of assigned CVs among the available CVs.

### FIELD

The present disclosure relates generally to system and method for scheduling multi-modal transportation network, and more particularly to system and method for assigning commuter vehicles (CVs) in a multi-modal transportation network having the CVs and fixed schedule vehicles to passengers.

### BACKGROUND

Obtaining a multi-modal route through a multi-modal transportation network presents certain challenges. Such transportation networks typically include sub-networks of different types, i.e. associated with different modes of transport. These differences in the properties of the different types of network make it difficult to generate a multi-modal route across both types of network, as a conventional routing and/or scheduling methods tend to be specific to a certain type of transportation network. Current attempts to obtain a multi-modal route involve exploring the different networks separately to determine routes there through. For example, a route may be determined from a departure point through a network associated with one mode of transport to a departure point for another mode of transport, and then a route from the departure point for the other mode of transport to the destination determined through a network associated with the other mode of transport.

Private transport routing, e.g. car routing algorithms, and public transportation routing tend to differ as a result of the different properties of such networks, with the consequence that they cannot readily be integrated to provide a true multi-modal route planner. However, no mention is made on the optimization jointly over the public and private transportation networks.

Accordingly, there is a need to generate multi-modal routes, e.g. to allow a system and a passenger to integrate their use of private transport and public transport between an origin and destination of interest, to provide a more efficient overall journey, and/or to reduce environmental impact.

### SUMMARY

The present disclosure relates to systems and methods for jointly controlling schedules of transport forming at least part of the multi-modal transportation network.

The present disclosure provides the use of autonomous vehicles in last-mile passenger transportation, which is defined as the service that delivers people from a hub of mass transit service to each passenger's final destination.

Embodiments of the present disclosure provide systems and methods for addressing problems of planning trips for passengers across multiple modes of transportation. Some embodiments provide a system and a method for controlling vehicles in a multi-modal transportation network including fixed schedule vehicles and commuter vehicles. Specifically, scheduling of passengers across two or more modes of transport consisting of: a first mode of a mass transportation network with fixed schedule vehicles, such as a air, boat, bus or train; and a second mode of a transportation network with flexibly scheduled commuter vehicles consisting of vehicles with smaller capacity such as cars operated by drivers, deriverless cars, minibuses, motorized platforms.

The fixed schedule vehicles have fixed schedules and unconstrained passenger capacities to transport a set of passengers between the transportation hubs of the corresponding service. For example, a train only transports passengers between train stations while the bus transports passengers between bus stops. As referred herein, the unconstrained passenger capacities can be understood as that of the maximum capacity of fixed schedule vehicles, which is not considered in the scheduling and controlling solution. In contrast, the commuter vehicles have unconstrained schedules, and a maximum passenger capacity to transport the passengers to or from the transportation hub via a route that is chosen according to the destinations of the passengers.

According to embodiments of the present disclosure, a system for assigning commuter vehicles (CVs) in a multi-modal transportation network having the CVs and fixed schedule vehicles to passengers, includes an interface to receive itinerary requests from the passengers, wherein the itinerary requests include initial locations, target locations, departure times from the initial locations, and arrival time windows including deadlines at the target locations. The system also includes a memory to store computer executable programs including a grouping program, a route-search program, an operation route map program of the CVs, and a commuter assigning program; and a processor to perform the computer executable programs in connection with the memory. The grouping program comprises formulating an optimization problem to determine groups of passengers based on the target locations of the passengers and to determine the start times on the fixed schedule vehicles and CVs for the passengers; solving the optimization problem to generate a solution defining the groups of passengers and the start times on the fixed schedule and CVs for the passengers; storing the solution obtained from solving the optimization problem in the memory, wherein the formulating, solving and storing are repeated for obtaining solutions for a set of weighting factors and combinations of total travel times of the passengers and a number of groups with; choosing a solution among the solutions obtained for linear combinations of the total travel times of the passengers and the number of groups; assigning the CVs to the groups and routes for the CVs by performing the commuter assigning program; generating assignment information of assigned CVs among the CVs based on the chosen solution, wherein the assignment information includes the assigned CVs to the groups, the routes assigned to the CVs, intermediate locations and start times of the assigned CVs from the intermediate locations; and transmitting the assignment information to the assigned CVs via the interface.

### BRIEF DESCRIPTION OF THE DRAWINGS

The presently disclosed embodiments will be further explained with reference to the attached drawings. The drawings shown are not necessarily to scale, with emphasis instead generally being placed upon illustrating the principles of the presently disclosed embodiments.

FIG. 1 is a schematic illustrating an integrated last-mile system, according to embodiments of the present disclosure;

FIG. 2 is a block diagram illustrating a system for scheduling multiple modes of transport;

FIG. 3A shows a block diagram of a commuter vehicle assigning system according to some embodiments of the present disclosure;

FIG. 3B shows a block diagram of a route search program according to some embodiments of the present disclosure;

FIG. 4 is a flowchart illustrating primary steps for scheduling passengers jointly on fixed schedule vehicles and commuter vehicles, according to embodiments of the present disclosure;

FIG. 5 is a flowchart illustrating primary steps in optimizing the scheduling of passengers on fixed schedule vehicles and commuter vehicles using an integer programming formulation, according to embodiments of the present disclosure;

FIG. 6 is a flowchart illustrating the assignment of commuter vehicles to to passengers using the output of the integer programming formulation, according to embodiments of the present disclosure;

FIG. 7 is a flowchart illustrating primary steps in optimizing the scheduling of passengers on fixed schedule vehicles and commuter vehicles using a network flow formulation, according to embodiments of the present disclosure;

FIG. 8 is a flowchart illustrating the assignment of commuter vehicles to to passengers using the output of the network flow formulation, according to embodiments of the present disclosure;

FIG. 9 is an example of the decision diagram representation of the groupings of passengers in the commuter vehicles, according to embodiments of the present disclosure;

FIG. 10A is a flowchart illustrating primary steps in optimizing the scheduling of passengers on fixed schedule vehicles and commuter vehicles using a branch and price formulation, according to embodiments of the present disclosure;

FIG. 10B is a flowchart illustrating the primary steps in assigning the start times on the fixed schedule vehicles and commuter vehicle for each passenger using the solution of the branch and price formulation according to embodiments of the present disclosure;

FIG. 11 is a flowchart illustrating primary steps in optimizing the scheduling of passengers on fixed schedule vehicles and commuter vehicles traveling to two destinations using a network flow formulation, according to embodiments of the present disclosure;

FIG. 12 is a flowchart illustrating the assignment of commuter vehicles to to passengers using the output of the network flow formulation when commuter vehhicles travel to two destinations, according to embodiments of the present disclosure;

FIG. 13 is an example of the decision diagram representation of the groupings of passengers in the commuter vehicles when traveling to two destinations, according to embodiments of the present disclosure;

FIG. 14 is a cumulative distribution plot of performance, comparing formulations BP and NF on set of test instances, according to embodiments of the present disclosure;

FIG. 15 is a computed result for the Pareto frontier in a few minutes for 10,000 passengers, 50 destinations, 600 CVs using the BP formulation, according to embodiments of the present disclosure;

FIG. 16 is a scatter plot comparing the BP and NF formulations, according to embodiments of the present disclosure;

FIG. 17 is a scatter depicting total passenger travel time and average number of CVs for different settings of weighting factor in the objective a.

While the above-identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

### DETAILED DESCRIPTION

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like reference numbers and designations in the various drawings indicated like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

By way of example, a multi-modal transportation network may include a public transportation sub-network, and a private transportation sub-network for use by private transport, e.g. a road network (a “private transportation sub-network” as referred to herein). These types of network have different properties. Times of entry, exit and travel through a public transportation network are constrained, such that entry, exit and travel through the network may only occur at specific times, i.e. in accordance with a schedule associated with the network. In contrast, such constraints do not exist in relation to a private transportation network, such as a road network, when using private transport. In a private transportation network, a user may choose to enter, exit or travel through the network freely, at a time of their choosing.

Examples of public transportation include various fixed schedule vehicles, i.e., vehicles with fixed and/or predetermined schedule and cannot be modified to suit the convenience or requirements of the user. Examples of the fixed schedule vehicles include one or combinations of a train, a bus, a boat, and a plane. Examples of private transportation include various flexibly scheduled commuter vehicles such as an autonomous vehicle, a semi-autonomous vehicle, and a vehicle operated by a driver. Flexibly scheduled commuter vehicles allow for their route times to be specified in accordance with the needs of the passengers.

### Overview

The present disclosure relates to systems and methods for jointly controlling schedules of transport forming at least part of the multi-modal transportation network.

The embodiments of the present disclosure provide systems and methods for addressing problems of planning trips for passengers across multiple modes of transportation. Some embodiments provide a system and a method for controlling vehicles in a multi-modal transportation network including fixed schedule vehicles and commuter vehicles. Specifically, scheduling of passengers across two or more modes of transport consisting of: a first mode of a mass transportation network with fixed schedule vehicles, such as a airplane, boat, bus or train; and a second mode of a transportation network with commuter vehicles consisting of vehicles with smaller capacity such as cars, vans, pods or motorized platforms that are either driven by a person or are autonomous.

The fixed schedule vehicles can have schedules that can be adapted to the needs of the passengers and unconstrained passenger capacities to transport a set of passengers to or from an intermediate location. As referred herein, the unconstrained passenger capacities can be understood as that of the maximum capacity of scheduled vehicles, which is not considered in the scheduling and controlling solution. In contrast, the commuter vehicles that can have unconstrained schedules, and a maximum passenger capacity to transport the passengers to or from the intermediate location via one of a route selected from a set of predetermined routes.

In addressing the problems of planning trips for passengers across multiple modes of transportation, the present disclosure considers passengers traveling from a set of stations for the fixed schedule vehicles to a set of buildings, to arrive at a time. There are a set of commuter vehicles (CVs), that take the passengers from or to their destination buildings. At least one aspect is to plan the schedules for the requests by passengers, so as to satisfy their arrival time windows. Another embodiment of the disclosure, consider passengers traveling from buildings to a set of of stations for fixed schedule vehicles where the passengers desire to leave the buildings by a certain time.

A realization of the present disclosure includes that once the groups of passengers that share a CV are specified then, the scheduling of the fixed schedule vehicles and CVs can be decoupled. In order to come to a solution to the problem, the solution process can include a first step defining a group as a subset of passengers numbering less than a capacity of the CV that ride together to reach their destinations. In a grouping process, the passengers are grouped into a set of groups based on the target locations and the arrival time windows such that each group is assigned to an identical target location among the target locations and the arrival time windows of the passengers include at least one common time instance, wherein the groups are assigned routes and intermediate locations by performing the route-search program using the operation route map program of the CVs, wherein the routes respectively reach the target locations of the groups from the intermediate locations, wherein the groups are assigned start times at the intermediate locations to allow the passengers of the groups to switch from the fixed vehicles to the CVs at the intermediate locations and reach the target locations within arrival time windows. The grouping of the passengers is accomplished by the choice of path in the decision diagram representation.
In the second step, given the set of groups, the second step determines for each group: (i) an assignment of CV to that group; and (ii) a time at which the group leaves the train station or train terminal, on the assigned CV. In doing so, an assigning algorithm loaded from the memory is performed as follows.
The CVs are assigned to the groups according to the following steps: determining a number of CVs used at every time instant based on the start times, the deadlines of the arrival time windows and the routes assigned to the groups; formulating an optimization problem based on variables representing the groups reaching the target locations; calculating total travel times of the passengers in the groups; minimizing a sum of the total travel times of all the passengers; generating solution values by solving the optimization problem to satisfy predetermined constraints including the arrival time windows of the passengers and ensuring that the number of CVs used at every instant of time is smaller than a total number of available CVs; and as part of the solving, repeating the grouping and assigning of CVs until the set of groups with minimum total travel time is obtained and the predetermined constraints are satisfied. In this case, each passenger has a total travel time that corresponds to a time period spent during the travel from a start time to an arrival time consumed by the passenger.

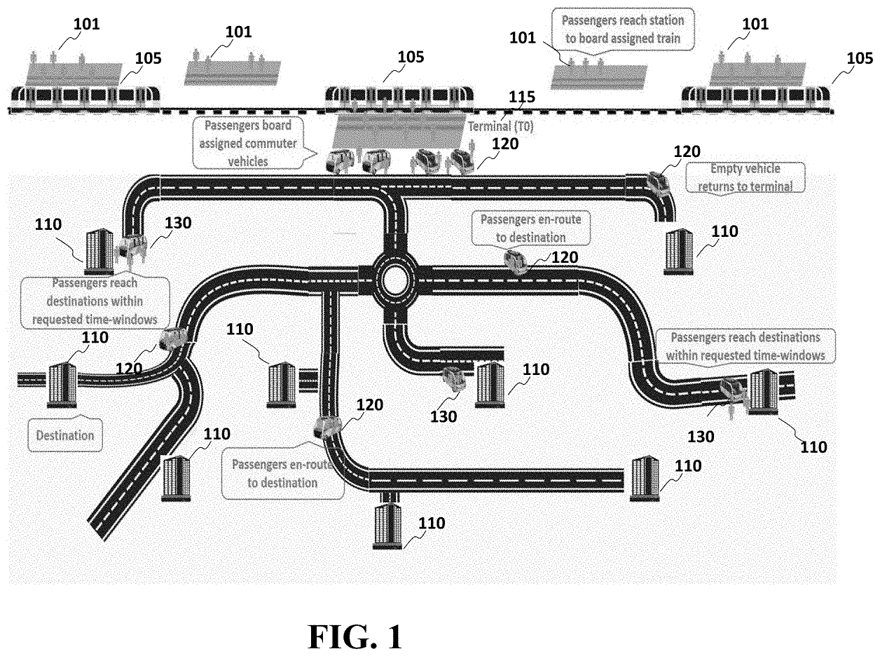

FIG. 1 is schematic illustrating an integrated last-mile system, according to embodiments of the present disclosure. The figure depicts the boarding of passengers 101 on a fixed schedule vehicle 105 such as a train, arrival at the intermediate station 115, boarding of passengers on commuter vehicles at the intermediate station, travel by commuter vehicles to reach destinations 120 and arrive at the destinations 110 within the speicfied time windows of arrival 130.

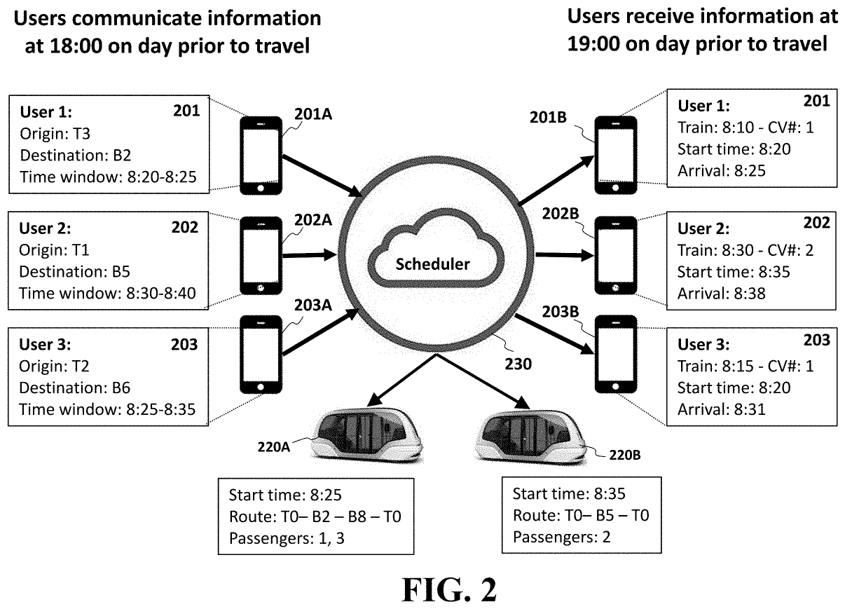

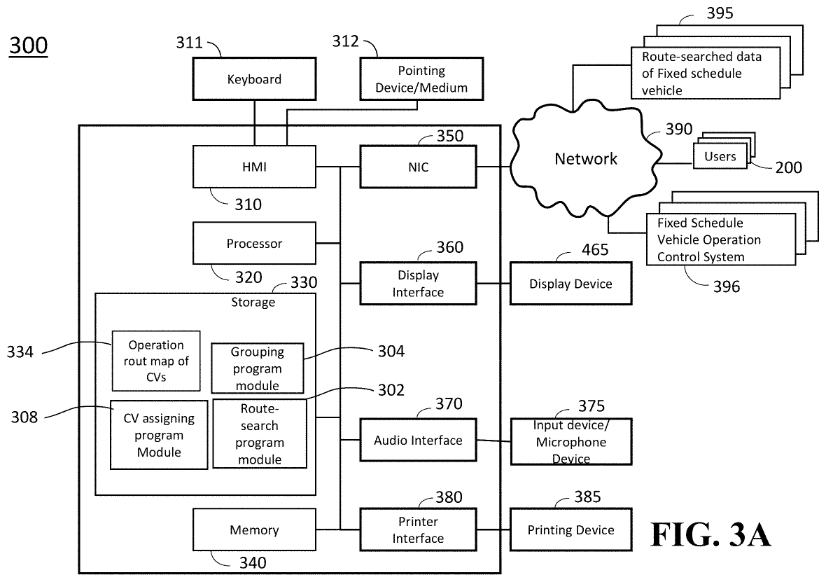

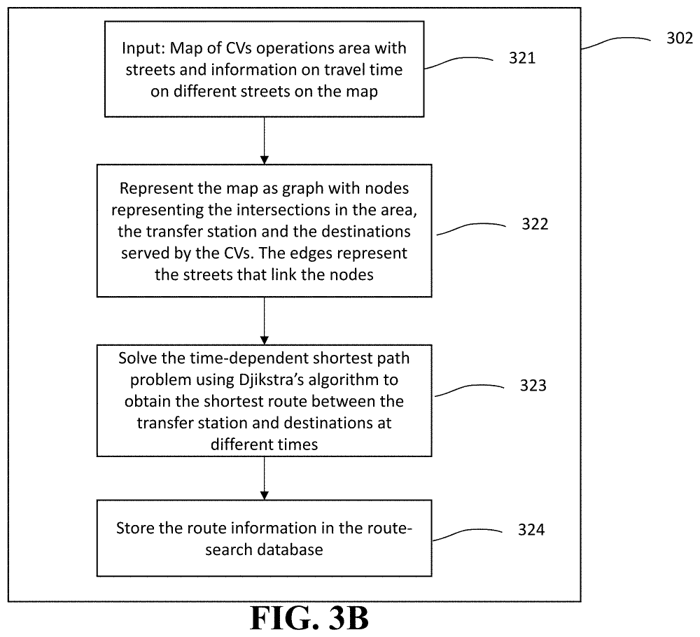

FIG. 2 is a schematic illustrating a system 300 which can assign commuter vehicles to efficiently connect with scheduled vehicles. An example of the system 300 is illustrated in FIG. 3A, by which passenegers communciate with the system 300 and receive their schedules, according to embodiments of the present disclosure.

FIG. 2 shows an example of the CV assigning system, where the users 201, 202, 203 provide input to the system 300 requesting the origin station, destination building and the time-window for arrival at the destination. Each user 201, 202, 203 communicates to the system 300 using their individual smart-phones or computers 201A, 202A, 203A. The system 300 determines the CV schedule for the users and the commuter vehicles 220. The system 300 communicates the optimal schedule for all passengers 201 through the preferred communcation device such as a smartphone 201 or computer. The user 201, 202, 203 receives information on the train time on which the passenger leaves station of origin, the id of the commuter vehicle that the user travels on, and the start and arrival times for the journay in the commuter vehicle.

FIG. 3A shows a block diagram of the system 300 according to some embodiments of the present disclosure. The system 300 may include a human machine interface (HMI) 310 connectable with a keyboard 311 and a pointing device/medium 312, one or more processor 320, a storage device 330, a memory 340, a network interface controller 350 (NIC) connectable with a network 390 including local area networks and internet network, a display interface 360, an audio interface 370 connectable with a microphone device 375, a printer interface 380 connectable with a printing device 385. The memory 340 may be one or more memory units, operating with the storage 330 that stores computer executable programs (algorithm codes) in connection with the processor 320. The CV assigning system 300 may receive itinerary request data (not shown) from passengers (users) 200, route-searched data of fixed schedule vehicles from public database or search results of public-opened route-search applications 395 via the network 390 connected to the NIC 350. The NIC 350 includes a receiver and transmitter to connect to the network 390 via wired-networks and via wireless-networks (not shown). In some cases, the itinerary request data may include user's preferred options having conditions, such as a lowest fare, a shortest travel time, or a shortest travel distance. When the system 300 receives the user's preferred options, the CV assigning system 300 performs the grouping program module 304 and the CV assigning program module 308 based on the conditions of the preferred option. For instance, when the preferred option indicates the lowest fare, the CV assigning system 300 generates an itinerary schedule providing an intermediate location (station) and the start time of a CV from the intermediate location, in which the itinerary schedule satisfies the condition of the lowest (minimum) total fare to be paid by the passenger to transport from the initial location to the target location.

The system 300 can provide information of the commuter vehicles 220, the start time of the trips, the routes that the commuter vehicles take, and the information on the passengers that are transported in those trips.

In some cases, if the passenger 200 possesses a commuter pass available between the initial location and a station (near-station) that is one stop near than the intermediate location from the initial location, the system 300 sets the near-station as the intermediate location such that the total fare of each passenger between the initial location to the target location can be less expensive. In such cases, the system 300 is configured to request the information of the passengers' commuter passes, e.g. available stations of the commuter pass.

Further, the system 300 can communicate with a fixed schedule vehicle operation control system 396 via the network 390. For instance, when the fixed schedule vehicle operation control system 396 obtains information on the latest changed schedules of the fixed schedule vehicles on-time, the interface 350 can receive the information of the changed schedules relevant to already assigned or to be assigned CV schedule, and the system 300 re-performs the grouping and CV assigning programs to obtain and transmit another assignment information to the passengers. Accordingly, the passengers can obtain reasonable CV assignment even if the schedule of the fixed schedule vehicles changed after the initial assignment information is transmitted to the passengers. This provides extremely effective seamless transportation for the passengers.

In some cases, the system 300 can receive the information regarding the current operation status of the scheduled vehicles from the fixed schedule vehicle operation control system 396 via the network 390 before assinging the scheduled vehicles to the passengers. For instance, while rush hours of day, the fixed schedule vehicle operation control system 396 provides the system 300 with an estimated passenger distribution (crowded condition) on each fixed schedule vehicle as a function of time hours of day. In other words, the fixed schedule vehicle operation control system 396 includes statistic data that can provide an estimated energy consumption of each of the fixed schedule vehicles operated in different time schedules in day for their operation sections. For instance, when a fixed schedule vehicle is operated in a crowded operation section during a rush hour, the energy consumption of the fixed schedule vehicle is greater than that operated in a non-rush hour for a non-crowded operation section. Accordingly, the fixed schedule vehicle operation control system 396 can provide information how much the energy consumption is reduced with another arrival time to the intermediate location (e.g. station) if the passengers shift the initially assigned start time to another start time or/and another route.

According to an embodiment of the present disclosure, the system 300 can generate information as to how much the energy consumption can be reduced if the passenger changes the assigned start time and the route to other start times and other routes, and can transmit the information to the passenger. This is a quite beneficial to reduce the total energy consumed by the fixed schedule vehicles, and can be a great environment-friendly system. Further, the fixed schedule vehicle operation control system 396 may include a rush-hour related dynamic pricing system. In this case, by communicating with the fixed schedule vehicle operation control system 396, the system 300 can generate information as to how much a fare of the fixed scheduled vehicle can be reduced and transmit the information to the passenger, in which the reduction of the fare is associated to the reduction of the energy consumption of the fixed vehicle according to a predetermined calculation method included the fixed schedule vehicle operation control system 396. This can be a great incentive for the passenger to choose an environment-friendly travel schedule which is transmitted from the system 300.

Further, the interface receives information on traffic conditions including traffic jams, traffic accidents and constructions on the operation route map via the network and the route-search program searches the routes of the groups so as to avoid the traffic conditions. This feature is a great beneficial for reducing the travel times of the passengers and the energy consumption of the CVs.

The scheduling of the passengers on the fixed schedule vehicles also reveals the extent of crowding on fixed schedule vehicles and the fixed schedule vehicles trips on which the crowding occurs. The crowding on fixed schedule vehicles leads to poor service quality as passengers feel claustrophobic and fatigued. Hence, the information on crowding is of significant value to the fixed schedule vehicle operators. Using such information, the fixed schedule operators can target specific customers that contribute to the crowding and offer financial incentives or disincentives as appropriate. For instance, the fixed schedule operator can charge higher fares to disincentivize the travel at particular times or offer discounted fares if the passenger offers to travel at a later time. Thus, the fixed schedule operator can interact with the passengers to influence their times of travel in order to provide them with a better quality of service.

The storage device 330 includes a grouping program module 304, a route-search program module 302, a commuter vehicle assigning program module 308, and CV operation route map database 334 (operation route map program). The pointing device/medium 312 may include modules that read programs stored on a computer readable recording medium. The CV operation route map database 334 includes roadmap data of the CV operation areas, which are used to compute (calculates) routes of the CVs in response to the itinerary requests.

For performing the program modules 302, 304 and 308, instructions may be transmitted to the system 300 using the keyboard 311, the pointing device/medium 312 or via the network 390 connected to other computers (not shown). The system 300 receives instructions via the HMI 310 and executes the instructions for performing CV assignments to the passengers using the processor 320 in connection with the memory 340, the grouping program module 304, the route-search program module 302, and the commuter vehicle assigning program module 308 stored in the storage device 330.

According to embodiments of the present disclosure, the system 300 is used for assigning commuter vehicles (CVs) in a multi-modal transportation network having the CVs and fixed schedule vehicles to passengers. The system 300 may include an interface 350 to receive itinerary requests from the passengers (users) 201, wherein the itinerary requests may include initial locations, target locations, departure times from the initial locations, and arrival time windows including deadlines at the target locations. Further the system 300 includes a memory (or/and storage) to store computer executable programs including a grouping program, a route-search program, an operation route map program of the CVs, and a commuter assigning program, and a processor 320 to perform the computer executable programs in connection with the memory. The grouping program includes steps formulating an optimization problem to determine groups of passengers based on the target locations of the passengers and to determine the start times on the fixed schedule vehicles and CVs for the passengers; solving the optimization problem to generate a solution defining the groups of passengers and the start times on the fixed schedule and CVs for the passengers; storing the solution obtained from solving the optimization problem in the memory, wherein the formulating, solving and storing are repeated for obtaining solutions for a set of weighting factors and combinations of total travel times of the passengers and a number of groups; choosing a solution among the solutions obtained for linear combinations of the total travel times of the passengers and the number of groups; assigning the CVs to the groups and routes for the CVs by performing the commuter assigning program; generating assignment information of assigned CVs among the CVs based on the chosen solution, wherein the assignment information includes the assigned CVs to the groups, the routes assigned to the CVs, intermediate locations and start times of the assigned CVs from the intermediate locations; and transmitting the assignment information to the assigned CVs via the interface.

In steps performed in the executable programs in the system 300, the optimization problem can be formulated to minimize a linear combination of a sum of the total travel times of all the passengers and the number of the groups, wherein the combination is performed using a weighting factor. In this case, the optimization problem includes constraints to ensure that passengers reach destination within the arrival time windows of the passengers and ensure that the number of passengers in the group is smaller than a number of seats in the CVs, wherein the route-search and operation route map programs provide respective travel times for the CVs, wherein the constraints ensure that the number of CVs operating simultaneously is smaller than a total number of available CVs stored in the memory. In this case, each of the passengers may be supposed to have a total travel time.

By performing the executable programs in the system 300, the computational time can be greatly reduced, and then the computation power consumption can be greatly reduced.

Further, in the system 300, the groups are assigned the routes and the intermediate locations by performing the route-search program using the operation route map program of the CVs, wherein the routes respectively reach the target locations of the groups from the intermediate locations, wherein the groups are assigned the start times at the intermediate locations to allow the passengers of the groups to switch from the fixed vehicles to the CVs at the intermediate locations and reach the target locations within the arrival time windows.

Further, the passengers assigned to an identical group share an identical CV. This provides a simpler data processing method of the system, which allows a high speed grouping and travel scheduling method, resulting less computational power consumption.

According to embodiments of the present disclosure, in the grouping discussed above, the grouping program may be performed by constructing and computing decision diagrams (DDs) for each of the target locations of the passengers, wherein each of the DDs is constructed based on a number of the passengers traveling to a common target location, the arrival time windows of the passengers and a seat capacity of each of the CVs.

This method can greatly improve the calculation speed of the grouping process, providing less power consumptions of a computer system including a processor/processors.

In some cases, the grouping program may sort the grouped passengers in ascending order of deadlines in the arrival time windows. This can provide a simpler method for grouping processes, and is extremely efficient when a number of passengers is increased.

Further, when an itinerary request of a passenger includes a preferred option that indicates a minimum total cost to be paid by the passenger, the passenger may be assigned to a group that satisfies another constrain for minimizing a sum of costs of a scheduled vehicle and an assigned CV. This can provide the passengers with a less fare travel schedule as the passengers' choice.

In some cases, the system 300 may communicate with the CVs so that the operation statuses of the CVs are monitored and updated by receiving a status information from each of the CVs via an information interface, wherein the operation statuses include locations of the CVs and a number of available seats of each of the CVs, wherein the updated operation statuses are stored into the memory. This makes the system 300 possible to ensure that the passengers can be appropriately assigned to the available seats of the CVs.

According to an embodiment, the memory 340 or/and storage 330 stores fares and time tables of the fixed schedule vehicles that stop at the intermediate locations. This can provide a flexible route with better traffic conditions.

Further, steps of the executable programs may comprise transmitting, via the interface, an itinerary to each of the passengers with a departure time of a fixed schedule vehicle accessible from an initial location, one of the intermediate locations and one of the assigned CVs so that each of the passengers reaches a corresponding intermediate location prior to the starting time of the one of the assigned CVs.

In some cases, the optimization problem may be formulated to minimize a linear combination of the total travel times and an energy to be consumed by the CVs, a total fare to be paid by each of the passengers, a linear combination of the total travel time and the total fare or a linear combination of the total travel time and an energy to be consumed by the fixed schedule vehicles. This provides the passengers less expensive services.

Further, when the itinerary includes the total fare, the optimization problem is solved to satisfy the total fare as one of the constraints. This provides the passengers more flexible choices for their travel schedules.

In some cases, in order to perform time-effective computation cycles to obtain the solutions, the steps of grouping, assigning, ensuring and evaluating are repeated until a predetermined time limit is reached on the processor.

Further, the interface can receive information on traffic conditions including traffic jams, traffic accidents and constructions on the operation route map via the network and the route-search program searches the routes of the groups so as to avoid the traffic conditions. This provides the passengers better services (less time consuming to the target locations), also reduce the total energy (fuel) to be spent by the CVs, reducing the energy consumptions of the CVs.

According to embodiments, the commuter assigning program solves the optimization problem based on one of constraints of the total travel time of the passengers, an energy used by the assigned CVs in transporting the passengers and a linear combination of the total travel time and the energy used in transporting the passengers. This can provide the passengers with flexible choices that allow less-energy consumption operations of the CVs.

Further, the system can transmit each passenger information as to how much a fare of the fixed scheduled vehicle is reduced if the passenger chooses an environment-friendly travel schedule. This can provide the passengers with an economical incentive to contribute the environment-friendly travel. This is a great benefit regarding an environment-friendly operations of the fixed scheduled vehicles.

FIG. 3B is an example illustrating a flowchart consisting of the elements of the route search program for the calculation of routes to be used by the commuter vehicles in reaching the requested passenger destinations. The route search program 302 has as in memory the map of the operation area of the CVs 321 which denote the streets on which the CVs can travel, the intersection between the streets and the time to travel on each of these streets at different times of the day. The information on the map is represented as a graph in step 322 where the nodes of the graphs are the intermediate station, street intersections and destinations and the edges in the graphs are the streets. Using the graph representation, the shortest paths between the intermediate station and destinations are computed in step 323 using the well-known Djisktra's algorithm at different times of travel from the transfer station and also the time to return is also computed in a similar manner. The information on such shortest time routes is stored in a database in step 324 for later use in the scheduling of passengers. Further, once a route is chosen or determined using the rout search program, a fare of the CV 321 is provided based on a CV fare calculation program (not shown) that calculates the fare of the CV 321 based on a distance of the determined route and an expected time to reach the target location from the corresponding intermediate location determined by the station of the fixed schedule vehicle.

In some cases, the system 300 may obtain the information on the shortest time routes from outside networks that provide the route information including the corresponding distance. The outside networks can be operated by third parties.

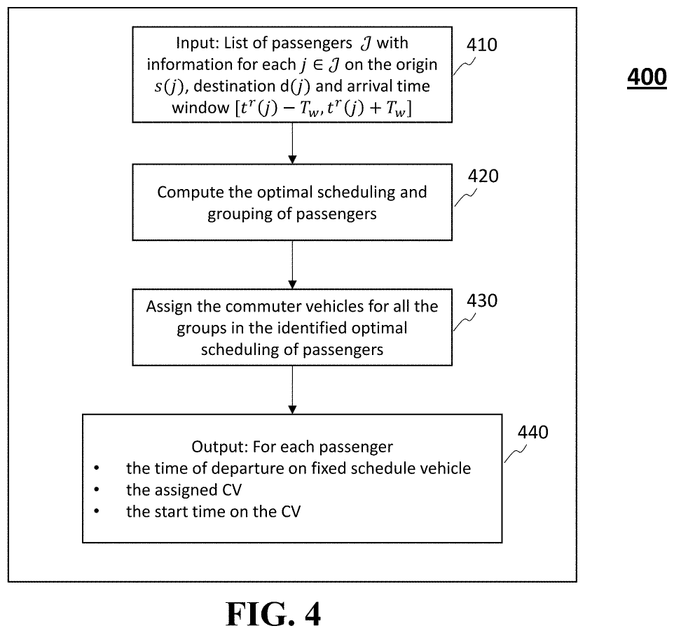

FIG. 4 is a flowchart illustrating a primary procedure 400 for scheduling passengers on the multiple modes of transportation, according to embodiments of the present disclosure. The procedure 400 performs an input step 410 where input data include the information on each passenger j∈ [symbol] on the origin s(j), destination d(j) and arrival time window [t^{r}(j) T_{w}, t^{r}(j)+T_{w}]. Using this information, the procedure 400 computes an optimal scheduling and grouping of the passengers in step 420 to minimize an objective such as the linear combination of total travel time of passengers and the number of CV trips. The computed solution is then used to identify the assignment of the commuter vehicles to the passengers in step 430. Finally, the assigned fixed schedule vehicle, start time and assigned commuter vehicle information is communicated to the passengers in step 440.

### Problem Description

Let T0 denote the intermediate station at which passengers transfer from fixed schedule vehicles to flexibly scheduled commuter vehicles (CVs). Let [symbol] be the set of destinations where the CVs make stops with T0∈ [symbol] . For each destination d∈ [symbol] , let t(d,t⁰)=t¹ (d,t⁰)+t²(d,t⁰)+t³ (d,t⁰) be the total time it takes a CV to depart T0, travel to d (denoted by t¹(d,t⁰), stop at d for passengers to disembark (denoted by t² (d,t⁰), and return to T0 (denoted by t³(d,t⁰)) when the CV leaves T0 at time t⁰. Let [symbol] ={1, . . . , T} be an index set of the operation times of both systems. The time required to board passengers into the CVs at T0 is incorporated in t¹(d,t⁰). Further, the passenger is said to have arrived at the destination after t¹(d,t⁰) time units after departing from the terminal at time t⁰.

The fixed schedule vehicle movement is described by a set of trips, denoted by [symbol] . Each trip c∈ [symbol] originates at a station in set s∈ [symbol] and ends at T0. The time a trip c leaves station s is \tilde{t}(c,s) and the time it arrives to T0 is \tilde{t}(c,T0).

Let [symbol] be the set of passengers. Each passenger j∈ [symbol] requests transport from a station j∈ [symbol] to T0, and then by CV to destination d(j)∈ [symbol] , to arrive in the time interval [t^{r}(j)−T_{w}, t^{r}(j)+T_{w}]. The set of passengers that request service to destination d is denoted by a [symbol] (d). Let n=| [symbol] | and n_{d}= [symbol] (d).

Let V be the set of CVs, with m:=|V|. Denote by v^{cap} the maximum number of passengers that can be assigned to a single CV trip. Each CV trip consists of a set of passengers boarding the CV, traveling from T0 to a destination d∈ [symbol] , and then returning back to T0.

The problem of scheduling passengers on the different modes of transport is equivalent to assigning trips on fixed schedule vehicles and CVs to each passenger so that an objective function is minimized. For instance, an example of the objective function is a linear combination of the total travel time and the number of CVs trips. The minimization of total travel times of passengers and a number of CVs trips are conflicting and a balance between them is achieved by specifying a weighting factor α, 0≤α≤1. Hence, the balanced objective is denoted as f(α) where f(α)=α(total travel time)+(1−α)(number of CV trips).

In some cases, the objective function may include energy consumptions of the scheduled vehicles and the CVs. The system 300 can generate and transmit information that indicates a travel schedule including the start time and the route, which can reduce or minimize the energy consumptions of the scheduled vehicles and the CVs.

The choice of the weighting factor α can be chosen arbitrarily based on the system operator's preferences or based on predetermined numbers (not shown) stored in the memory. In addition, a system operator can solve the problem of scheduling passengers for different choices of the weighting factor, for example α∈{0,0.5,1.0}. The system operator can then choose one of the solutions based on a reasonable trade-off between the two conflicting objective.

A feasible scheduling of the passengers consists of a partition g=g₁, . . . , g_{γ} of, with each group gₗ associated with a departure time t⁰(gₗ), for l=1, . . . , γ, which indicates the time the CV carrying the passengers in gₗ departs, satisfying all request time and operational constraints. For any passenger j∈ [symbol] , let g(j) be the group to which that passenger j belongs to.

In a feasible scheduling of the passengers, the number of groups is identical to the number of CV trips.

### Integer Programming Formulation

In one embodiment of the invention, the problem of scheduling passengers on multiple modes of transport can be formulated as a integer program (IP). The IP variables consist of:
∀j∈ [symbol] , ttⱼ—total travel time for passenger j
∀j∈ [symbol] , ∀c∈ [symbol] ,x_{j,c}—indicator if passenger j is assigned to fixed schedule trip c
∀j∈ [symbol] , ∀t∈ [symbol] , z_{j,t}—indicator if passenger j leave T0 at time t
∀t∈ [symbol] , nₜ—number of CVs parked at T0 at time t
∀t∈ [symbol] , d∈ [symbol] ,n_{d,t}—number of CVs assigned to destination d to depart T0 at time t

The objective function of the IP formulation is:

$$f ( α ) = α {\sum }_{j ∈ 𝒥} {tt}_{j} + ( 1 - α ) \cdot {\sum }_{d ∈ 𝒟} {\sum }_{t ∈ 𝒯} {n}_{d , t} \qquad ( IP . 1 )$$

which is a linear combination of the total travel time for all the passengers and the number of CV trips required to transport the passengers with a weighting factor α∈[0,1].

The constraints in the IP formulation are:

ttⱼ= [symbol] (t+t¹(d(j),t))·z_{j,t}− [symbol] \tilde{t}(c,s(j))·x_{j,c}∀j∈ [symbol] (IP. 2)
where the constraint links time at which passenger j boards the trip c at station s(j) and arrives at destination d(j) on a CV that leaves terminal at time t

[symbol]

=1∀j∈ [symbol] (IP.3)
where the constraint specifies that the passenger j is assigned to one CV.

[symbol]

==1∀j∈ [symbol] (IP.4)
where the constraint specifies that the passenger j is assigned to one of the trips.

t^{r}(j)−T_{w}≤ [symbol] (t+t¹(d(j),t))·z_{j,t}≤t^{r}(j)+T_{w}∀j∈ [symbol] (IP.5)
where the constraint specifies that the time of arrival of the passenger j is within the passenger's time window of arrival at the destination d(j).

nₜ=nₜ₋₁+ [symbol] n_{d,t-t(d,t)}− [symbol] n_{d,t}∀t∈ [symbol] (IP. 6)
where the constraint keeps track of the number of vehicles that are available at T0 based on the CVs that are already in service and number that are leaving for service at the time instant t.

[symbol]

≤v^{cap}·n_{d,t}∀d∈ [symbol] ∀t∈ [symbol] (IP. 7)
where the constraint ensures that the capacity of the CV is satisfied.

[symbol]

≥v^{cap}·(n_{d,t}−1(∀d∈ [symbol] ∀t∈ [symbol] (IP. 8)
where the constraint ensures that the number of CVs assigned is just sufficient to satisfy the number of passengers traveling.

ttⱼ≥0 ∀j∈ [symbol] (IP. 9)
where the constraint specifies nonnegativity requirement on the travel time for passenger j.

x_{j,c}≤1−z_{j,t}∀j∈ [symbol] ,∀c∈ [symbol] ,∀t∈ [symbol] :\tilde{t}(c,T0)>t (IP. 10)
where the constraint specifies that the passenger j starts on the CV trip at a time t that is after the arrival to T0 of the trip c to which the passenger is assigned

x_{j,c}∈{0,1}∀j∈ [symbol] ,∀C∈ [symbol] (IP.11)
where specifies that the variable is binary.

z_{j,t}∈{0,1}∀j [symbol] ,∀t∈ [symbol] (IP.12)
where the constraint specifies that the vaiable is binary.

nₜ≥0∀t∈ [symbol] (IP.13)
where the constraint specifies that the variable is nonnegative.

n_{d,t}≥0∀d∈ [symbol] ,∀t∈ [symbol] (IP. 14)
where the constraint specifies that the variable in nonnegative.

n₀=|V| (IP. 15)
where the constraint specifies the number of CVs parked at T0 at the initial time t=0.

The IP problem formulation can be written as:

min(IP. 1) s.t. Eqs. (IP. 2)-(IP.15) (IP)

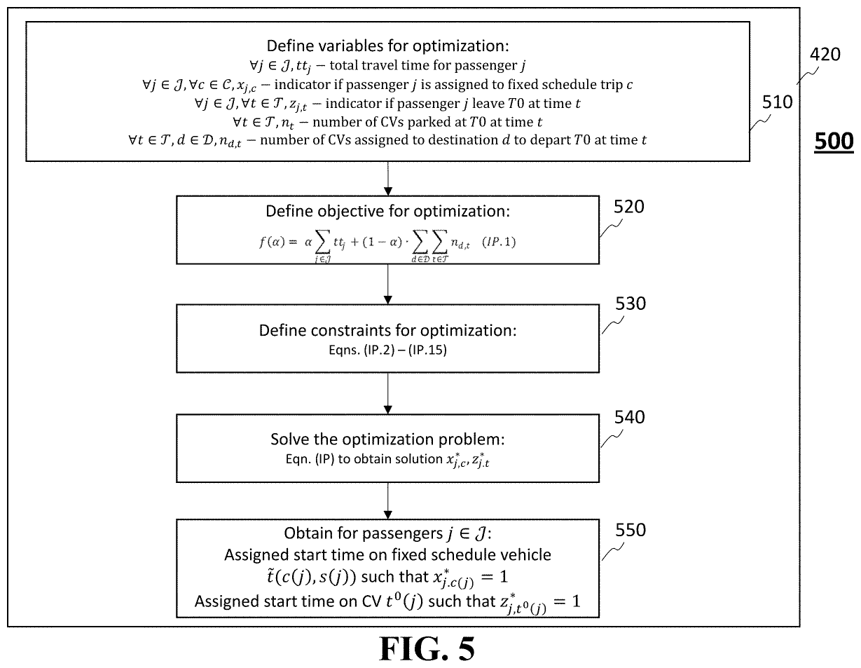

FIG. 5 is a schematic of an example algorithm 500 to implement the step 420 of FIG. 4 for obtain an optimal scheduling of the passengers using the integer programming formulation. The algorithm 500 defines the optimation variables 510, formulates the objective 520, defines the constraints in the optimization problem 530, solves the optimization problem to obtain the optimal solutions 540. The obtained optimal solution is then used to determine the start time on the fixed schedule vehicle and the start time on the commuter vehicle for each passenger 550.

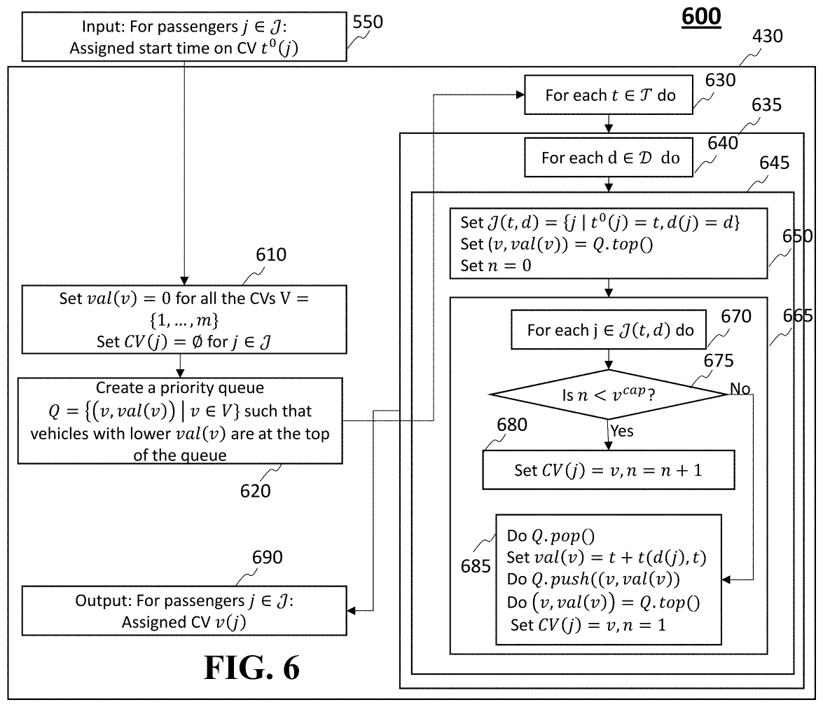

FIG. 6 is a schedmatic of an example algorithm 600 to implement the step 430 of FIG. 4 for determining the assignment of the commuter vehicles to the passengers given as input the start time on the commuter vehicles for all the passengers 550. The algorithm proceeds by assigning to each commuter vehicle a label val (v)=0 for all the CVs V={1, . . . , m} 610. Using these labels a priority queue Q={(v, val(v))|v∈V} is created such that the vehicles with lower val(v) are at the top of the queue 620. A loop is executed for each time instant of operation t∈ [symbol] 630, for each destination d∈ [symbol] 640. The algorithm chooses the vehicle at the top of the queue 650 and incrementally assigns passengers from j∈ [symbol] (t,d) 670 whose start times on the commuter vehicle are the same as the current of value of t in the loop 630. For each such passenger it is checked if the current commuter vehicle's capacity has been reached 675. If not, the passenger is assigned to that vehicle and the current occupancy of the vehicle if increased 680. If the capacity has been exceeded then the value of the label val(v) is increased 685 and the is pushed into the queue. A new vehicle is taken from the top of the queue and is assigned to the passenger and the occupancy is updated 685.

### State-Space Decomposition

In one embodiment of the invention, the scheduling of the passengers on multiple modes of transport is performed through decision diagram (DD) decomposition. In such an embodiment, a compact decision diagram is used to represent the possible groupings of passengers for a particular destination called the single destination decision diagram (DD).

### Single Destination DD

For each destination d∈ [symbol] , a decision diagram D^{d} is constructed. The DD D^{d} is a layered-acyclic directed graph D^{d}=(N^{d}, A^{d}) where N^{d} is the set of nodes in the DD and A^{d} is the set of arcs in the DD. The set of nodes N^{d} is partitioned into (n_{d}+2) ordered layers L₀^{d}, . . . , Lₙ_{_{d}}₊₁^{d} where n_{d}=| [symbol] (d)|. Layer L₀^{d}={r^{d}} and Lₙ_{_{d}}₊₁^{d}={t^{d}} consisting of one node each representing the root and terminal respectively. The layer of node u∈Lᵢ^{d} is defined as l(u)=i. Each arc a∈A^{d} is directed from its arc-root ψ(a) to its acr-terminal ω(a), with l(w(a))=l(ψ(a))+1. The arc-layer of a is denoted as l(a):=ψ(a). The layers {L₁^{d}, . . . , Lₙ_{_{d}}^{d}} of the DD correspond to passengers {j₁ . . . , jₙ_{_{d}}} ordered in nondecreasing order of t^{r} such that t^{r}(jₖ)≤t^{r}(jₖ). Each node u is associated with a state [symbol] (u) that denotes the number passengers already aboard the CV in the DD. The DD consists of two classes of cars: one-arcs and zero-arcs, indicated by ϕ(a)=1,0 respectively. A one-arc stores an η(a) and an arc-start time t⁰(a) denoting the start time on the CV. The arc-cost of an arc corresponds to the total objective function incurred by a set of passengers, and the arc-start time indicates the time at which the passengers depart from T0 on a CV. A zero-arc does not have these attributes.

The DD D^{d} for destination d represents every feasible partition of a [symbol] (d) into groups of passengers that can board the CV based on the ordering of the passengers. The set [symbol] ^{d} be the set of arc-specified r^{d}-to-t^{d} paths in D^{d}. For any path p∈ [symbol] ^{d}, the groups g(p) composing the partition defined by p are as follows. Every one-arc a in p corresponds to group g(a)={ [symbol] _{(ψ(a))}, [symbol] _{(ψ(a))+1}, . . . , jₗ₍ₐ₎}, i.e., the set of contiguously indexed passengers ending in index l(a) of sizes [symbol] (ψ(a))+1. The partition defined by p is g(p):=U_{a∈A}_{^{d}}_{:ϕ(a)=1}g(a) The DDs are constructed such that for every arc-specified r^{d}-to-t^{d} has exactly one occurence of each passenger j∈ [symbol] (d), i.e. g(j)∈g(p) is unique.

Since the one-arcs also have start times on the CVs, the paths also dictate the time that each group g∈g(p) departs T0. The time t⁰(a) indicates the start time on the CV and hence, the CV continues to be in service for the time instants t∈[t⁰(a), t⁰(a)+t(d,t⁰(a))]. The construction of the DD ensures that the arrival time to destination d is feasible for each group, i.e. t⁰(a)+t¹(d,t⁰(a))∈[t^{r}(j)−T_{w}, t^{r}(j)+T_{w}] for all j∈g(a).

The objective function value on the arcs can be obtained as

η(a):=αΣ_{j∈g(a)}(t⁰(a)+t¹(d(j),t⁰(a))− [symbol] \tilde{t}(c,s(j)))+(1−α) (DD.1)

Where the first term is scaled by α and places emphasis on the total travel time and second term places the emphasis on the number of trips.

The cost of a path p∈ [symbol] ^{d} is denoted as η(p)=Σ_{a∈p:ϕ(a)=1}η(a).

### DD Generation

For each destination d∈ [symbol] , a decision diagram D^{d} is constructed using the procedure described next. Zero-arcs in the DD are added as follows. For i=1, . . . , n_{d}−1 and [symbol] =0, . . . , v^{cap}−2, add zero-arcs connecting the node with state [symbol] on layer Lᵢ^{d} to the node with state [symbol] +1 on layer Lᵢ₊₁^{d}. For each passenger j, let t^{e}(j,t), t^{l}(j,t) represent the earliest, latest possible departure time from T0 if the passenger travels on a CV that leaves at time t. This can be calculated as

$${t}^{e} ( j ) = max \{ {t}^{r} ( j ) - {t}^{1} ( d ( j ) , t ) , {min}_{c ∈ 𝒞 : t \geq \tilde{t} ( c , s ( j ) )} \{ \tilde{t} ( c , s ( j ) ) \} \}$$

$${t}^{l} ( j ) = max \{ {t}^{r} ( j ) + {t}^{1} ( d ( j ) , t ) , {max}_{c ∈ 𝒞 : t \geq \tilde{t} ( c , s ( j ) )} \{ \tilde{t} ( c , s ( j ) ) \} \}$$

One-arcs in the DD are added as follows. For i=1, . . . , n_{d} and [symbol] =0, . . . , v^{cap}−1, consider the node u∈Lᵢ^{d} with state [symbol] . For t=t^{e}(jᵢ), t^{e}(jᵢ)+1, . . . , t^{l} [symbol] , add one-arc a from u to the node on layer Lᵢ₊₁^{d} with state 0. Set t⁰(a)=t and arc cost η(a) is computed as defined in Eq. (DD.1). The arcs in the DD that do not belong to any r^{d}-to-t^{d} paths are deleted.

### Network-Flow Formulation

Given, for each d∈ [symbol] , a decision diagram D^{d} the optimal scheduling of passengers is posed as a consistent path problem. In each DD, a path is selected so that at any instant of time t∈ [symbol] , no more than |V| CVs in use to transport passengers to their destination. This can be stated formally as, for every d∈ [symbol] , a path p^{d}∈ [symbol] ^{d} such that, for every t, the number of one-arcs with t⁰(a)≤t≤t⁰(a)+t (a,t⁰(a)) is less than or equal to |V|. Let χ(a,t)∈{0,1} indicate that a CV is active at time t, i.e.

$$χ ( a , t ) = \{ \begin{matrix}1 & if {t}^{0} ( a ) \leq t \leq {t}^{0} ( a ) + t ( a , {t}^{0} ( a ) ) \\ 0 & otherwise\end{matrix} .$$

The optimal scheduling of the passengers can be posed as a network-flow formulation. The variables in the formulation are:

yₐ∈{0,1}∀a∈A^{d} indicating choice of arc a.

The objective function can be formulated as

$${\sum }_{d ∈ 𝒟} {\sum }_{a ∈ {A}^{d}} η ( a ) {y}_{a} \qquad ( NF . 1 )$$

The constraints in the network-flow formulation are:

Σ_{a:ψ(a)=r}_{^{d}}yₐ=1∀d∈ [symbol] (NF. 2)
where constraint enforces that exactly one arc from the root node of each DD is chosen.

Σ_{a:ψ(a)=t}_{^{d}}yₐ=1∀d∈ [symbol] (NF. 3)
where constraint enforces that exactly one arc to the terminal node of each DD is chosen.

Σ_{a:ψ(a)=u}yₐ−Σ_{a:ω(a)=u}yₐ=0 ∀d∈ [symbol] ,∀u∈N^{d}\{r^{d},t^{d}} (NF. 4)
where constraint enforces that if an incoming arc is chosen for a particular node then an outgoing arc is also chosen for that node.

[symbol]

[symbol]

yₐ≤|V|∀t∈ [symbol] (NF. 5)
where constraint enforces that number of CVs that are in use at any instant of time is less than or equal to |V|.

yₐ∈{0,1}∀a∈A^{d} (NF. 6)
where constraint enforces the variables are binary valued.

The optimization problem for the network-flow formulation can be written as

min(NF. 1) s.t. Eqs. (NF. 2)-(NF. 6) (NF)

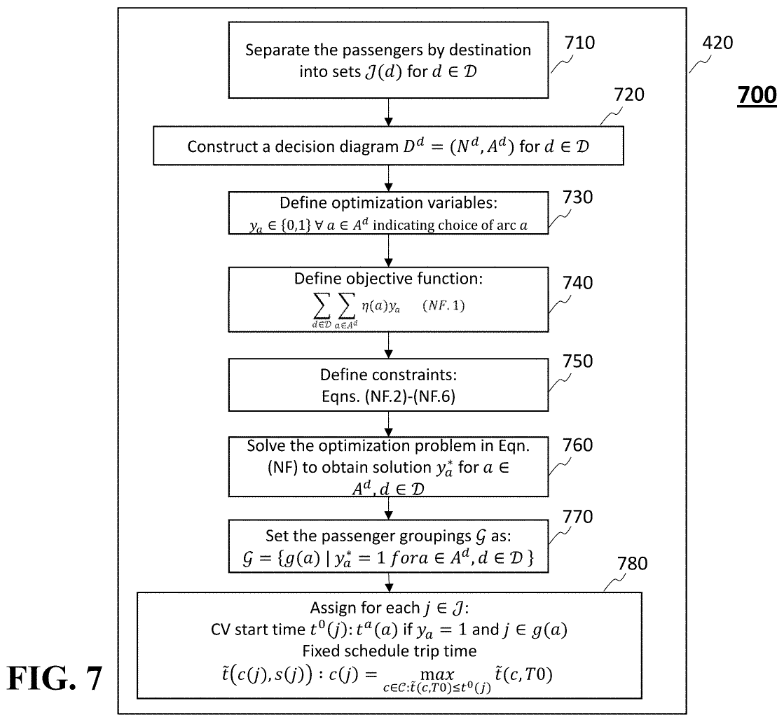

FIG. 7 a schematic of another example algorithm 700 to implement the step 420 of FIG. 4, according to embodiments of the present disclosure. The algorithm 700 is illustrated using a flowchart of the steps involved in the optimal scheduling of the passengers using the network flow formulation. The procedure first separates the passengeres by destination 710. For each such destination a decision diagram is constructed 720. The decision variables for the optimization problem are defined 730. The objective function Eq. (NF.1) is formulated 740 and the constraints are defined 750. The optimization problem Eq. (NF) is solved 760 to obtain the optimal solution. The solution is used to define the passenger groupings 770 and assigns the start time on the commuter vehicle and the fixed schedule trip time for each passenger 780.

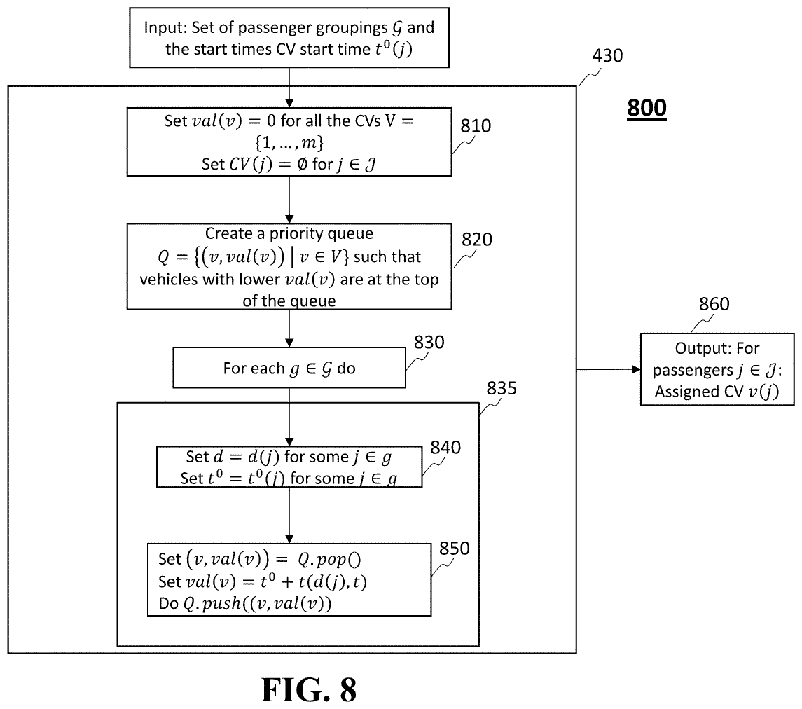

FIG. 8 is a schedmatic of another example algorithm 800 to implement the step 430 of FIG. 4, according to embodiments of the preesnt disclosure. The algorithm 800 provides the assignment of commuter vehicles to passengers based on the set of passenger groupings and commuter vehicle start times obtained from solving the network flow formulation. The algorithm 800 proceeds by assigning to each commuter vehicle a label val(v)=0 for all the CVs V={1, . . . , m} 810. Using these labels a priority queue Q={(v,val(v)|v∈V} is created such that the vehicles with lower val(v) are at the top of the queue 820. A loop is executed for each group g∈ [symbol] 830, the destination and start time for the CV is picked according to that for group 840. The algorithm chooses the vehicle at the top of the queue 850, the value of the label val(v) is increased 850 and the is pushed into the queue 850.

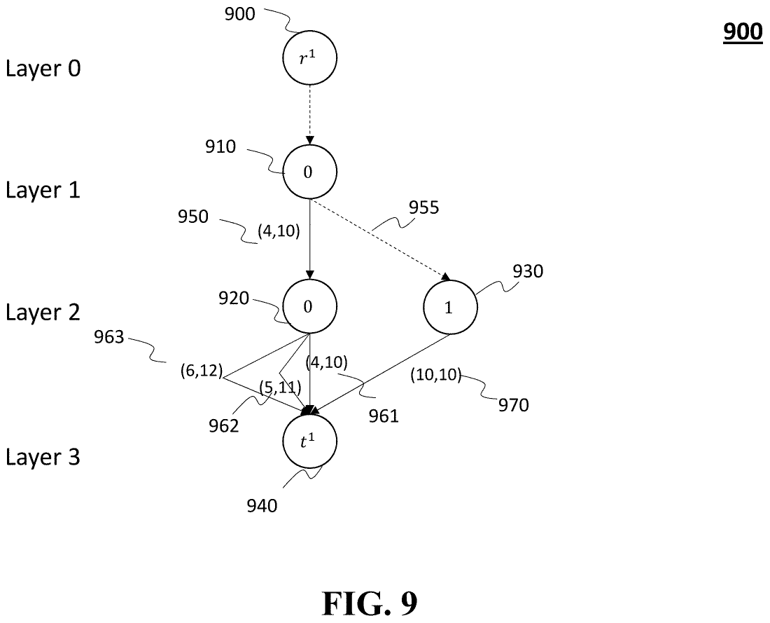

FIG. 9 is an example of the decision diagram representation of the groupings of passengers in the commuter vehicles, according to embodiments of the present disclosure.

Suppose there are 2 passengers requesting service to the same destination where the passengers request to arrive at their destinations in the time windows, times of arrival at the origin stations are:
Passenger 1: arrival time window: [10,12], origin station: 1
Passenger 2: [12,14], origin station: 2.

The fixed schedule vehicles consist of two trips where the times of departure
at the different stations are:
Trip 1: station 3: 4, station 2: 6, station 1: 8, T0: 10
Trip 2: station 3: 8, station 2: 10, station 1: 12, T0: 14.
   The time to reach the destination on the commuter vehicles is 2 and the capacity of the commuter vehicles is 2.

Passenger 1 can travel alone by arriving on Trip 1 and reaching the destination after traveling on commuter vehicle at 12. The total travel time is 4 and only possible start time on commuter vehicle is 10. This denoted in the decision diagram by an arc 950 with label (4,10) denoting the total travel time and start time on commuter vehicle. This arc is drawn from the 0-node of Layer 1 910 to 0-node of Layer 2 920 and is a one-arc.

Passenger 2 can travel alone by arriving on Trip 1 and reaching the destination after traveling on commuter vehicle at 12. The total travel time is 6 and the possible start time on commuter vehicle is 10, 11, 12. For these different start times the total travel times are 6, 7, 8 respectively. Accordingly, 5 different arcs with labels: (6,10) 961, (7,11) 962, (8,12) 963 respectively. These arcs drawn between 0-node on Layer 2 and terminal-node of Layer 3 940.

A 0-arc 955 is drawn between 0-node on Layer 2 to 1-node on Layer 3 indicating the joint travel of passengers 1 and 2 on the commuter vehicle. The two passengers can jointly travel on a commuter vehicle by arriving on Trip 1 and traveling on commuter vehicle starting at time 10. The total travel time for this group is 10 and this is indicated in the 1-arc joining 1-node on Layer 2 to terminal node on Layer 3.

### Branch & Price Formulation

In another embodiment of the invention, a so-called Exponential Formulation (EF) may be used to find the optimal scheduling of the passengers. In the EF formulation, the variables are:

zₚ∈{0,1}∀p∈ [symbol] indicating the choice of a path from DD D^{d}

In addition for each path is associated with k (p,t) denoting the number of CVs that are used at a particular time instant t, i.e. k(p,t)=Σ_{a∈p:ϕ(a)-1}χ(a,t).

The objective function in the EF formulation is

$${\sum }_{d ∈ 𝒟} {\sum }_{p ∈ {𝒫}^{d}} η ( p ) {z}_{p} \qquad ( EF . 1 )$$

The constraints in the EF formulation are:

[symbol]

zₚ=1 ∀d∈ [symbol] (EF. 2)
where the constraint enforces exactly one path is chosen from each DD D^{d}.

[symbol]

[symbol]

k(p,t)zₚ≤|V|∀t∈ [symbol] (EF. 3)
where the constraint enforces the number of CVs in use at any time instant is less than or equal to the available number of CVs.

zₚ∈{0,1}∀d∈ [symbol] ,∀p∈ [symbol] (EF. 4)
where the constraint enforces that the variables are binary valued.

The EF formulation can be posed as

min(EF. 1) s.t. Eqs. (EF. 2)-(EF. 4) (EF)

The optimization formulation in (EF) has an exponential number of variables and cannot be solved as stated in an efficient manner. To address this problem a Branch & Price (BP) algorithm is disclosed.

The BP algorithm proceeds by defining an initial search-tree node with no branching decisions and choose for d∈ [symbol] , a subset of paths [symbol] ⊆ [symbol] are chosen. Denote by [symbol] := [symbol] [symbol] . With the subset of paths an optimization problem called as the restricted master problem (RMP) is defined. The variables in the RMP are:
zₚ∈{0,1}∀p∈ [symbol] indicating the choice of a path from DD D^{d}

The objective function in the RMP formulation is

$${\sum }_{d ∈ 𝒟} {\sum }_{p ∈ {\tilde{𝒫}}^{d}} η ( p ) {z}_{p} \qquad ( RMP . 1 )$$

The constraints in the RMP formulation are:

[symbol]

zₚ=1 ∀d∈ [symbol] (RMP. 2)
where the constraint enforces exactly one path is chosen from each DD D^{d}.

[symbol]

[symbol]

k(p,t)zₚ≤|V|∀t∈ [symbol] (RMP. 3)
where the constraint enforces the number of CVs in use at any time instant is less than or equal to the available number of CVs.

zₚ∈{0,1}∀d∈ [symbol] ,∀p∈ [symbol] (RMP.4)
where the constraint enforces that the variables are binary valued.

The RMP formulation can be posed as
min(RMP. 1) s.t. Eqs. (RMP. 2)-(RMP. 4) (RMP)

The linear programming relaxation of the RMP, denoted as LPRMP, is obtained by replacing the binary requirement in (RMP. 4) with zₚ≥0 ∀d∈ [symbol] , ∀p∈ [symbol] .

The LPRMP is solved using column generation where the paths p∈ [symbol] [symbol] are added if the associated variable in (EF) has a reduced cost that is negative at the solution corresponding to LPRMP for the chosen paths in [symbol] . This is accomplished using a pricing problem that is described below.

Denote by μ_{d}∀d∈ [symbol] the Lagrange multiplier associated with (RMP.2) at the optimal solution of the LPRMP. Denote by λₜ∀t∈ [symbol] the Lagrange multiplier for (RMP.3) at the optimal solution of the LPRMP.

The pricing problem (PP) to identify paths that have negative reduced cost is:

For each d∈ [symbol] , define arc-costs θ(a) for one-arcs as θ(a)=η(a)+ [symbol] ₜχ(a,t)
For each d∈ [symbol] , the minimum cost paths r^{d}-to-t^{d}, p^{d} in D^{d} is determined using the arc costs θ(a). Such calculations can be performed using the well known Djikstra's algorithm.
For each d∈ [symbol] , the path p^{d} is added to [symbol] if the reduced cost defined as, Σ_{a∈p}_{^{d}}_{:ϕ(a)-1}θ(a)−μ_{d}<0.

Solving the (RMP) as an integer program results in a feasible solution to the scheduling of passengers. A branch-and-bound search is conducted to complete the BP algorithm. A queue of search-tree nodes Γ is defined, initialized as a singleton γ′. At any point in the execution of the algorithm, each search node γ∈Γ is defined by a set of branch decisions out(γ), in(γ). The branch-and-bound search maintains the best known solution z* and its objective value f*.

While Γ≠ø, a search node γ is selected to explore. The chosen node is the one with the worst LPRMP relaxation of the search node from which it was created. The LPRMP relaxation for the search node γ is solved using column generation as described before. If the optimal objective value of the LPRMP(γ) is greater than f* then the node is pruned, and the search continues by selecting another node in r. Otherwise, the integer program in (RMP) is solved and the solution z′ with objective value f′ is obtained. If f is lower than f* then z*, f* are replaced by z′, f′ respectively. Let yₚ* denote the optimal value to the LPRMP. The path p= [symbol] |yₚ*−0.5| that is the most fractional is selected to branch on. Two nodes γ⁰, γ¹ are created with in(γ⁰)=in(γ),out(γ⁰)=out(γ)∪{p} and in(γ¹)=in(γ)∪{p} and out(γ¹)=out(γ), and update the search tree as Γ=Γ∪{γ⁰,γ¹}\{γ}.

### Finding an Initial Feasible Solution

An initial feasible solution to RMP is obtained by defining a path p^{d,0} for each d∈ [symbol] in which no passengers are assigned, i.e. χ(a,t)=0 for all arcs in the paths and having a objective value that is larger than a feasible solution to the passenger scheduling problem. The LPRMP is solved with this to obtain the Lagrange multipliers used in the pricing problem (PP) to obtain the paths with negative reduced costs for each d∈ [symbol] . Once such paths have been identified this paths p^{d,0} are removed from subsets [symbol] .

### Identifying a Feasible Solution

Suppose that yₚ*∀p∈ [symbol] is the optimal solution the LPRMP and the solution is not integral. Denote by p^{d}=arg [symbol] yₚ*the path with largest fractional value in the solution. Denote by g(p^{d}) the groups defined by the path p^{d}. Define the earliest t^{e}(g) and latest t^{l}(g) CV start times for the group g∈g(p^{d}) as

$${t}^{e} ( g ) = {max}_{j ∈ g} {t}^{e} ( j ) , \\ {t}^{l} ( g ) = {max}_{j ∈ g} {t}^{l} ( j )$$

The objective value associated with particular start time t∈[t^{e}(g), t^{l}(g)] is denoted as

$$η ( g , t ) = α {\sum }_{j ∈ g} ( t + {t}^{1} ( d , t ) - {max}_{c ∈ 𝒞} \tilde{t} ( c , s ( j ) ) ) + ( 1 - α ) \qquad ( FIP . 1 )$$

Denote by χ(g,t,t′)∈{0,1} an indicator to show if a CV is used by the group g at time instant t′ after starting from the T0 at time t.

The variable in the optimization problem is x_{g,t}∈{0,1} indicating if the group starts CV trip at time t.

The constraints in the optimization problem are:

Σₜ₌ₜ_{^{e}}_{(g)}^{t}^{^{l}}^{(g)}x_{g,t}=1∀g∈g(p^{d}) (FIP. 2)

where the constraint enforces exactly one start time for the CV is chosen for each group.

[symbol]

Σₜ₌ₜ_{^{e}}_{(g)}^{t}^{^{l}}^{(g)}χ(g,t,t′)x_{g,t}≤|V|∀t∈ [symbol] (FIP. 3)

where the constraint enforces that the number of CVs in simultaneous use is less than or equal to the number of available ones.

x_{g,t}∈{0,1}∀g∈ [symbol] g(p^{d}) (FIP.4)

where the constraint enforces the variables are binary valued.

The optimization problem for finding a feasible solution is

min (FIP.1) s.t. Eqs. (FIP. 2)-(FIP. 4) (FIP)

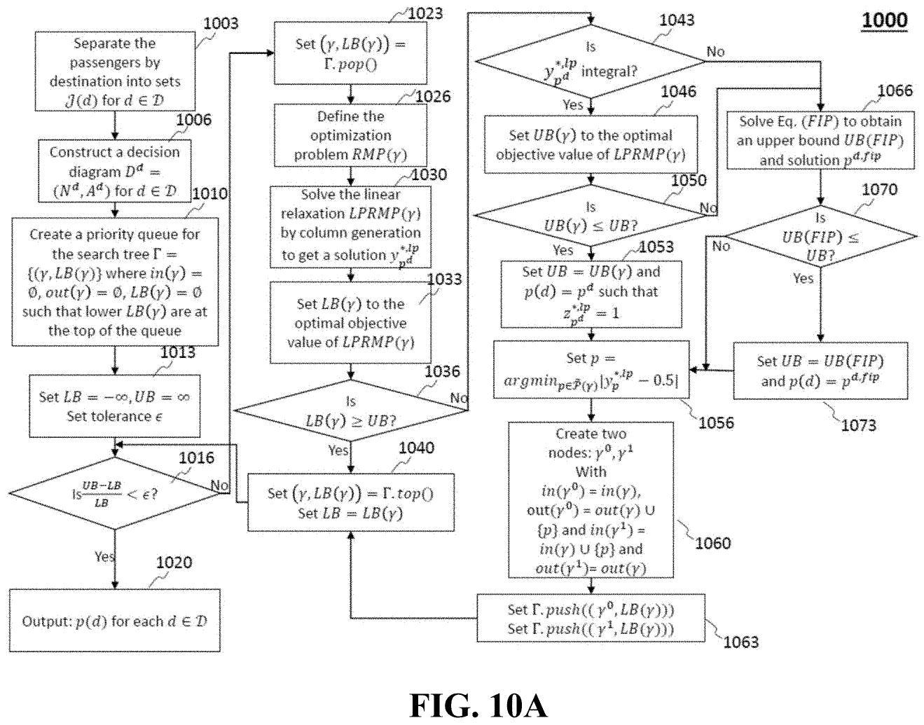

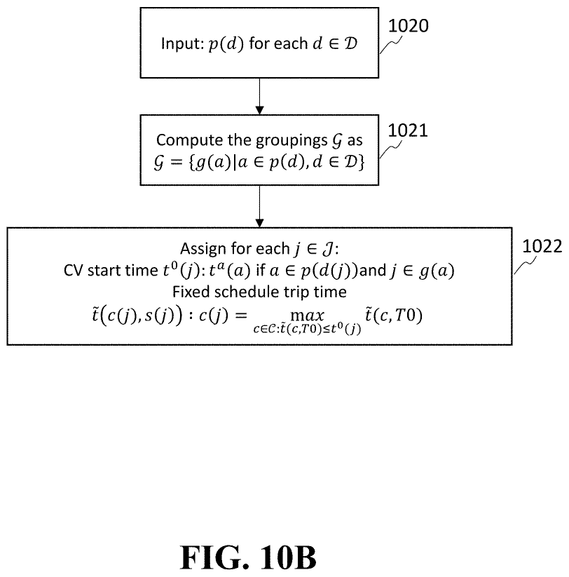

FIG. 10A is an illustration of the flowchart for optimizing the scheduling of the passengers on multiple modes of transporation using the Branch & Price formulation in BP. The procedure starts by separating the passengers into groups by destination. A decision diagram is constructed for each destination 1006, and a search tree Γ={(γ, LB(γ)} where in(γ)=ø, out(γ)=ø, LB(γ)=ø such that lower LB(γ) are at the top of the queue 1010. The lower bound and upper bound for the problem are initialized 1013. The algorithm checks if the lower and upper bound are close to each other in 1016. If this is true then the algorithm outputs the optimal path in the decision diagram for each destination. If not, the algorithm chooses the top element in the search tree 1023. The algorithm defined by the optimization problem RMP (γ) 1026 and the linear relaxation problem is solved 1030 to obtain the optimal solution of the linear program. The objective value of the LPRMP(γ) is assigned to be the lower bound LB(γ) 1033. The algorithm checks if the lower bound for the node is higher than or equal to the upper bound for the tree 1036. If true, then this node is fathomed and algorithm proceeds to pick another node 1040. If not, the algorithm checks if the solution of the linear program is integral 1043. If the solution is integral then the algorithm sets the upper bound for the node 1046 and checks if the upper bound for the node is better than the upper bound for the search tree 1050. If this is true, then upper bound for the search tree is updated and the optimal paths in each decision diagram are updated 1053. The algorithm chooses a path on which to branch 1056 and creates two child nodes 1060 and appends these to the search tree 106 and the algorithm proceeds to the next node in the search tree. If the solution of the linear relaxation is not integral, then the algorithm attempts to find a feasible solution by solving the optimization problem (FIP) 1066. The optimal objective value for the (FIP) is checked against the upper bound for the search tree 1070. If the upper bound is better then the upper bound for the tree and optimal solution are updated 1073. The algorithm proceeds to branch as described earlier 1056. If the upper bound is not better than that for the tree then again the algorithm proceeds to branch as described earlier 1056.

FIG. 10B illustrates an example of the assignment of the start time on the commuter vehicles and fixed schedule vehicles to the passengers, and the determination of the groupings of the passengers. The algorithm takes as input the optimal paths in the different decision diagrams 1020. The groupings of passengers are determined based on the paths 1021 and the start times of the fixed schedule vehicles and commuter vehicles are determined 1022.

Using the optimal groupings of passengers the vehicles that are assigned to passengers can be determined using the procedure outline in the flowchart in FIG. 8.

### Two Destination DD

In another embodiment of the invention, the passengers are grouped without restriction on the destinations. For instance, each of the CVs may include the passengers that are traveling to different destinations. If the sytem 300 determines, based on assignment results which indicate close disntace target locations, close time-windows, two or more than two target destinations are close distances and their calculated routes are similar, and the CV has enough available seats for the passengers or the assignment information of the assigned CVs includes an identical intermediate locations and start times of the assigned CVs from the intermediate locations, and the target locations and the arrival time windows satisfy a predetermined time period, then the system 300 selects and performs a multi-destinations grouping program and a multi-destination CV assigning program instead of the grouping program and the commuter assigning program.

The following describes the representation of the decision diagram when groups serve not more than two destinations. The steps described in the following can also be applied to consruct decision diagrams for destinations that are more than two.

Let [symbol] ² denote the set of pairs of destinations with no overlap between the pairs, i.e. for (d₁,d₂)∈D² and (d₃,d₄)∈D² d₁≠d₃,d₁≠d₄,d₂≠d₃,d₂≠d₄. For each (d₁,d₂)∈D², a decision diagram D^{d}^{₁}^{,d}^{₂} is constructed. The DD D^{d}^{₁}^{,d}^{₂} is a layered-acyclic directed graph D^{d}^{₁}^{,d}^{₂}=(N^{d}^{₁}^{,d}^{₂},A^{d}^{₁}^{,d}^{₂}) where N^{d}^{₁}^{,d}^{₂} is the set of nodes in the DD and A^{d}^{₁}^{,d}^{₂} is the set of arcs in the DD. The set of nodes N^{d}^{₁}^{,d}^{₂} is partitioned into (n_{d}_{₁}+n_{d}_{₂}+2) ordered layers

$${L}_{0}^{{d}_{1} , {d}_{2}} , … , {L}_{{n}_{{d}_{1} , {d}_{2} + 1}}^{{d}_{1} , {d}_{2}}$$

where n_{d}_{₁}_{,d}_{₂}=| [symbol] (d₁)|+| [symbol] (d₂)|. Layer L₀^{d}^{₁}^{,d}^{₂}={r^{d}^{₁}^{,d}^{₂}} and

$${L}_{{n}_{{d}_{1} , {d}_{2} + 1}}^{{d}_{1} , {d}_{2}} = \{ {t}^{{d}_{1} , {d}_{2}} \}$$

consisting of one node each representing the root and terminal respectively. The layer of node u∈Lᵢ^{d}^{₁}^{,d}^{₂} is defined as l(u)=i. Each arc a∈A^{d}^{₁}^{,d}^{₂} is directeed from its arc-root ψ(a) to its arc-terminal ω(a), with l (ω(a))=l(ψ(a))+1. The arc-layer of a is denoted as l(a):=ψ(a). The layers

$$\{ {L}_{1}^{{d}_{1} , {d}_{2}} , … , {L}_{{n}_{{d}_{1} , {d}_{2}}}^{{d}_{1} , {d}_{2}} \}$$

of the DD correspond to passengers

$$\{ {j}_{1} , … , {j}_{{n}_{{d}_{1} , {d}_{2}}} \}$$

ordered in nondecreasing order of t^{r} such that t^{r}(jₖ)≤t^{r}(jₖ). Each node u is associated with a state [symbol] (u) that denotes the number passengers already aboard the CV in the DD. The DD consists of two classes of arcs: one-arcs and zero-arcs, indicated by ϕ(a)=1,0 respectively. A one-arc stores an η(a) and an arc-start time t⁰(a) denoting the start time on the CV. The arc-cost of an arc corresponds to the total objective function incurred by a set of passengers, and the arc-start time indicates the time at which the passengers depart from T0 on a CV. A zero-arc does not have these attributes.

The DD D^{d}^{₁}^{,d}^{₂} for destinations (d₁,d₂) represents every feasible partition of [symbol] (d₁)∪ [symbol] (d₂) into groups of passengers that can board the CV based on the ordering of the passengers. The set [symbol] be the set of arc-specified r^{d}^{₁}^{,d}^{₂}-to-t^{d}^{₁}^{,d}^{₂} paths in D^{d}^{₁}^{,d}^{₂}. For any path p∈ [symbol] , the groups g(p) composing the partition defined by p are as follows. Every one-arc a in p corresponds to group g(a)={ [symbol] _{(ψ(a))}, [symbol] _{(ψ(a))+1}, . . . , jₗ₍ₐ₎}, i.e., the set of contiguously indexed passengers ending in index l(a) of size [symbol] (ψ(a))+1. The partition defined by p is g(p:=∪_{a∈A}_{^{d}}₁_{^{,d}}_{2:ϕ(a)=1}g(a). The DDs are constructed such that for every arc-specified r^{d}^{₁}^{,d}^{₂}-to-t^{d}^{₁}^{,d}^{₂} has exactly one occurence of each passenger j∈ [symbol] (d₁)∪ [symbol] (d₂), i.e. g(j)∈g(p) is unique.

Since the one-arcs also have start times on the CVs, the paths also dictate the time that each group g∈g(p) departs T0. The time t⁰(a) indicates the start time on the CV and hence, the CV continues to be in service for the time instants t∈[t⁰(a),t⁰(a)+t(d₁,d₂,t⁰(a))] where t(d₁,d₂,t⁰(a)) is the shortest travel time for serving the destination d₁, then destination d₂ and returning back to T0 when the CV starts from T0 at time t⁰(a). The construction of the DD ensures that the arrival time to destination d is feasible for each group, i.e. t⁰(a)+t¹(d₁,d₂,t⁰(a); d(j))∈[t^{r}(j)−T_{w},t^{r}(j)+T_{W}] for all j∈g(a), where t¹(d₁,d₂,t⁰(a); d(j)) is the time to reach the destination d(j)∈{d₁,d₂}.

The objective function value on the arcs can be obtained as

η(a):=αΣ_{j∈g(a)}(t⁰(a)+t¹(d₁,d₂,t⁰(a);d(j))− [symbol] \tilde{t}(c,s(j)))+(1−α) (DD.1)

Where the first term is scaled by α and places emphasis on the total travel time and second term places the emphasis on the number of trips.

The cost of a path p∈ [symbol] is denoted as η(p)=Σ_{a∈p:ϕ(a)=1}η(a)

### DD Generation

For each destination (d₁,d₂)∈D², a decision diagram D^{d}^{₁}^{,d}^{₂} is constructed using the procedure described next. Zero-arcs in the DD are added as follows. For i=1, . . . , n_{d}_{₁}_{,d}_{₂}−1 and [symbol] =0, . . . , v^{cap}−2, add zero-arcs connecting the node with state [symbol] on layer Lᵢ^{d}^{₁}^{,d}^{₂} to the node with state [symbol] +1 on layer Lᵢ₊₁^{d}^{₁}^{,d}^{₂}. For each passenger j, let t^{e}(j,t), t^{l}(j,t) represent the earliest, latest possible departure time from T0 if the passenger travels on a CV that leaves at time t. This can be calculated as

$${t}^{e} ( j ) = max \{ {t}^{r} ( j ) - {t}^{1} ( {d}_{1} , {d}_{2} , t ; d ( j ) ) , {min}_{c ∈ 𝒞 : t \geq \tilde{t} ( c , s ( j ) )} \{ \tilde{t} ( c , s ( j ) ) \} \}$$

$${t}^{l} ( j ) = max \{ {t}^{r} ( j ) + {t}^{1} ( {t}^{1} ( {d}_{1} , {d}_{2} , t ; d ( j ) ) , {max}_{c ∈ 𝒞 : t \geq \tilde{t} ( c , s ( j ) )} \{ \tilde{t} ( c , s ( j ) ) \} \}$$

One-arcs in the DD are added as follows. For i=1, . . . , n_{d} and [symbol] =0, . . . , v^{cap}−1, consider the node u∈Lᵢ^{d}^{₁}^{,d}^{₂} with state [symbol] . For t=t^{e}(jᵢ),t^{e}(jᵢ)+1, . . . , t^{l} [symbol] , add one-arc a from u to the node on layer Lᵢ₊₁^{d}^{₁}^{,d}^{₂} with state 0. Set t⁰(a)=t and arc cost η(a) is computed as defined in Eq. (DD.1). The arcs in the DD that do not belong to any r^{d}^{₁}^{,d}^{₂}-to-t^{d}^{₁}^{,d}^{₂} paths are deleted.

### Network-Flow Formulation

Given, for each (d₁,d₂)∈ [symbol] , a decision diagram D² the optimal scheduling of passengers is posed as a consistent path problem. In each DD, a path is selected so that any instant of time t∈ [symbol] , no more than |V|CVs in use to transport passengers to their destination. This can be stated formally as, for every (d₁,d₂)∈ [symbol] , a path p^{d}^{₁}^{,d}^{₂}∈ [symbol] such that, for every t, the number of one-arcs with t⁰(a)≤t≤t⁰(a)+t(a, t⁰(a)) is less than or equal to |V|. Let χ(a,t)∈{0,1} indicate that a CV is active at time t, i.e.

$$χ ( a , t ) = \{ \begin{matrix}1 & if {t}^{0} ( a ) \leq t \leq {t}^{0} ( a ) + t ( a , {t}^{0} ( a ) ) \\ 0 & otherwise\end{matrix} .$$

The optimal scheduling of the passengers can be posed as a network-flow formulation. The variables in the formulation are: yₐ ∈{0,1}∀a∈A^{d}^{₁}^{,d}^{₂} indicating choice of arc a.

The objective function can be formulated as

$${\sum }_{d ∈ {𝒟}^{2}} {\sum }_{a ∈ {A}^{{d}_{1} , {d}_{2}}} η ( a ) {y}_{a} \qquad ( NF 2.1 )$$

The constraints in the network-flow formulation are:

Σ_{a:ψ(a)=r}_{^{d}}₁_{^{,d}}₂yₐ=1∀(d₁, d₂)∈ [symbol] (NF2.2)
where constraint enforces that exactly one arc from the root node of each DD is chosen.

Σ_{a:ψ(a)=t}_{^{d}}₁_{^{,d}}₂yₐ=1∀(d₁,d₂)∈ [symbol] (NF2.3)
where constraint enforces that exactly one arc to the terminal node of each DD is chosen.

Σ_{a:ψ(}a)=uyₐ−Σ_{a:ω(a)=u}yₐ=0∀(d₁,d₂)∈ [symbol] ,∀u∈N^{d}^{₁}^{,d}^{₂}\{r^{d}^{₁}^{,d}^{₂},t^{d}^{₁}^{,d}^{₂}} (NF2.4)
where constraint enforces that if an incoming arc is chosen for a particular node then an outgoing arc is also chosen for that node.

[symbol]

Σ_{a∈A}_{^{d}}₁_{^{,d}}_{2:χ}_{^{(a,t)}}yₐ≤|V|∀t∈ [symbol] (NF2.5)
where constraint enforces that a number of CVs that are in use at any instant of time is less than or equal to |V|.

yₐ∈{0,1}∀a∈A^{d}^{₁}^{,d}^{₂} (NF2.6)
where constraint enforces the variables are binary valued.

The optimization problem for the network-flow formulation can be written as

min(NF2.1) s.t. Eqs. (NF2.2)-(NF2.6) (NF2)

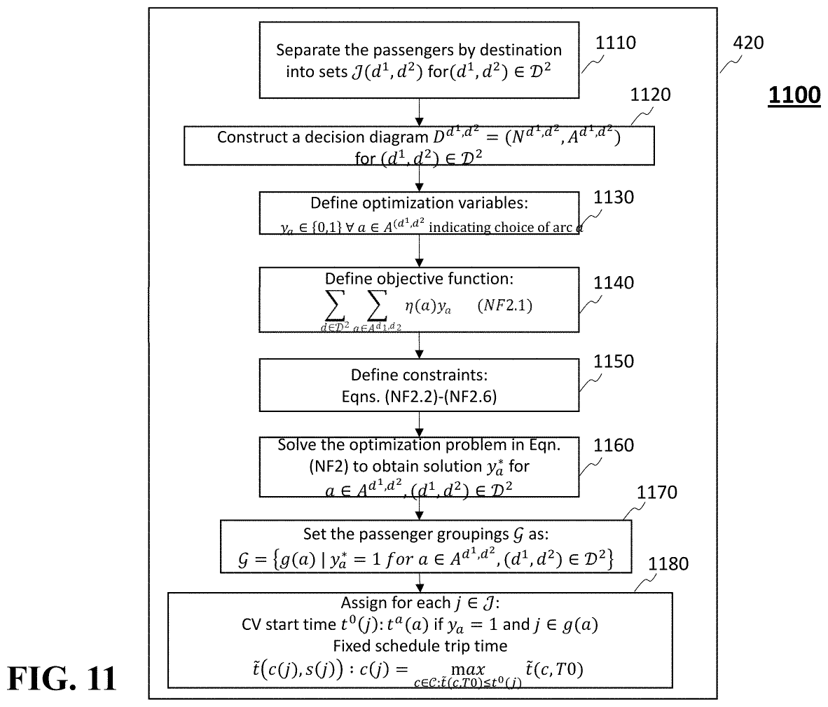

FIG. 11 a schematic of another example algorithm 1100 to implement the step 420 of FIG. 4, according to embodiments of the present disclosure. The algorithm 110 is illustrated using a flowchart for optimally scheduling passengers when the commuter vehicles travel to two destinations using the formulation in Eq. (NF2). The set of passengers are separated in those served by the pairs of destinations 1110. A decision diagram is constructed for each of the pair of destinations 1120. The optimization variables are defined based on the decision diagrams 1130 and the objective function 1140, constraints 1150 are defined. The optimization problem Eq. (NF2) is solved 1160 to obtain the optimal solutions. The optimal solutions are used to define the optimal groupings of passengers 1170 and the start times on the commuter vehicles, fixed schedule vehicles 1180.

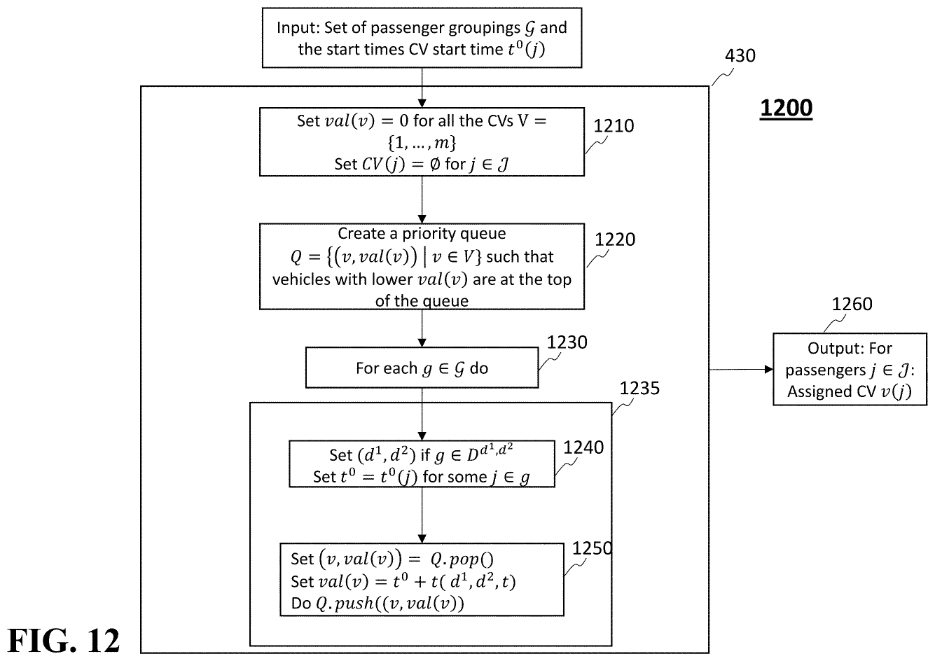

FIG. 12 is a schedmatic of another example algorithm 1200 to implement the step 430 of FIG. 4, according to embodiments of the present disclosure. The algorithm 1200 is illustrated by a flowchart for assigning the commuter vehicles to the passengers in the two-destination network flow formulation. The algorithm 1200 takes an input the optimal groupings of passengers obtain by solving the Eq. (NF2). The algorithm proceeds by asigning to each commuter vehicle a label v al (v)=0 for all the CVs V={1, . . . , m} 1210. Using these labels a priority queue Q={(v, val(v))|v∈V} is created such that the vehicles with lower val(v) are at the top of the queue 1220. A loop is executed for each group g∈ [symbol] 1230, the destination and start time for the CV is picked according to that for group 1240. The algorithm chooses the vehicle at the top of the queue 1250, the value of the label val (v) is increased 1250 and the is pushed into the queue 1250.

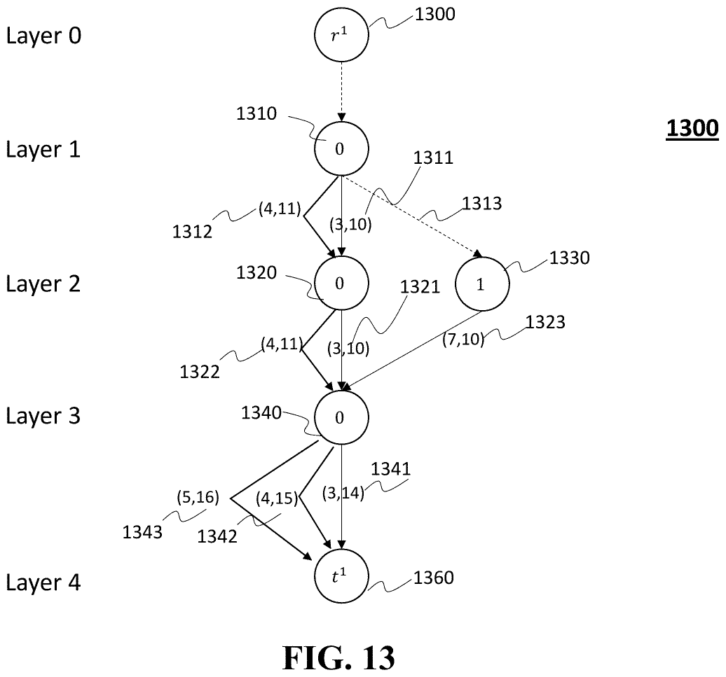

FIG. 13 is an example of the decision diagram representation of the groupings of passengers in the commuter vehicles when traveling to two destinations, according to embodiments of the present disclosure. Suppose there are 3 passengers requesting service to two destination where the passengers request to arrive at their destinations in the time windows, times of arrival at the origin stations are:

Passenger 1: arrival time window: [10,12], origin station: 1, destination: 1

Passenger 2: [10,12], origin station: 1, destination: 2

Passenger 3: [15,17], origin station: 1, destination: 1

The fixed schedule vehicles consist of two trips where the times of departure at the different stations are:

Trip 1: station 3: 4, station 2: 6, station 1: 8, T0: 10

Trip 2: station 3: 8, station 2: 10, station 1: 12, T0: 14.

The time to reach destination 1 or detination 2 on the commuter vehicles from terminal T0 is 1 and time to reach destination 2 from destination 1 is 1.

Passenger 1 can travel alone by arriving on Trip 1 and reaching the destination after traveling on commuter vehicle at 10. The total travel time is 3 and when possible starting at time on commuter vehicle is 10. This denoted in the decision diagram by an arc 1311 with label (3,10) denoting the total travel time and start time on commuter vehicle. This arc is drawn from the 0-node of Layer 1 1310 to 0-node of Layer 2 1320 and is a one-arc. Another 1-arc 1312 indicating a start time on commuter vehicle of 11 and total travel time of 4 is also drawn.

Passenger 2 can travel alone by arriving on Trip 1 and reaching the destination 2 after traveling on commuter vehicle. The total travel time is 3, 4 and the possible start time on commuter vehicle is 10, 11. Accordingly, 2 different 1-arcs with labels: (3,10) 1321, (4,11) 1322, respectively. These arcs drawn between 0-node on Layer 2 1320 and 0-node of Layer 3 Layer 3 1340.

A 0-arc 1313 is drawn between 0-node on Layer 2 to 1-node on Layer 3 indicating the joint travel of passengers 1 and 2 on the commuter vehicle. The two passengers can jointly travel on a commuter vehicle by arriving on Trip 1 and traveling on commuter vehicle starting at time 10. The total travel time for this group is 7 and this is indicated in the 1-arc joining 1-node 1330 on Layer 2 to 0-node on Layer 3 1340.

The passenger 3 can travel alone on a commuter vehicle to reach destination 1 after arriving on Trip 2. The possible start time for this trip is 14 and total travel time is 3. This is indicated by 1-arc 1341 joining 0-node 1340 on Layer 3 to terminal-node 1360 on Layer 4. Additional 1-arcs indicating start times on commter vehicles of 15 1342 and and 16 1343 are also drawn.

The passengers 2 and 3 can travel together only on a commuter vehicle starting at any time. Hennce, there exists no 1-node on Layer 3.

### Numerical Evaluation

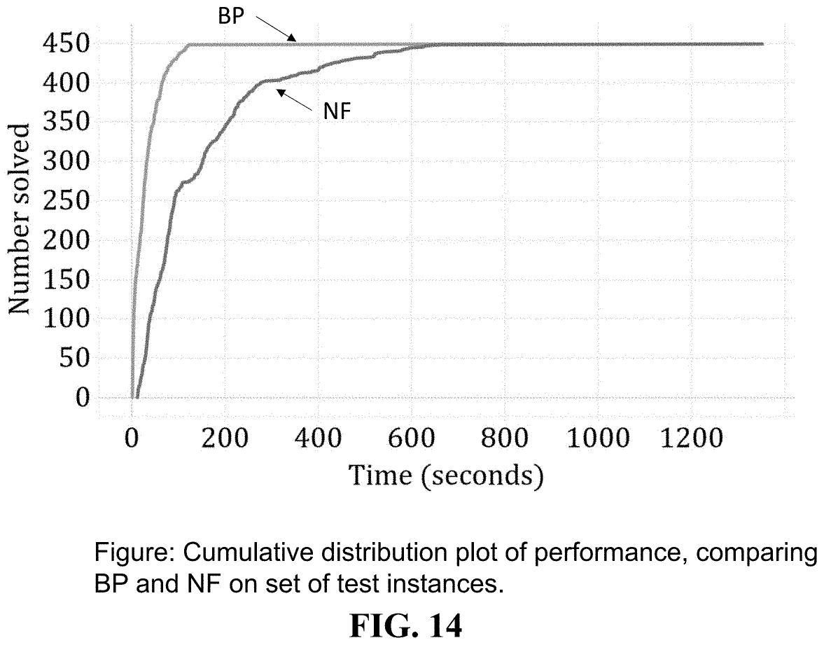

FIG. 14 is a cumulative distribution plot of performance, comparing formulations BP and NF on set of test instances, according to embodiments of the present disclosure. The plot clearly shows that the formulation based on Branch & Price is superior in terms number of problems solved at any given time budget. BP solves all problems in less than 3 minutes.

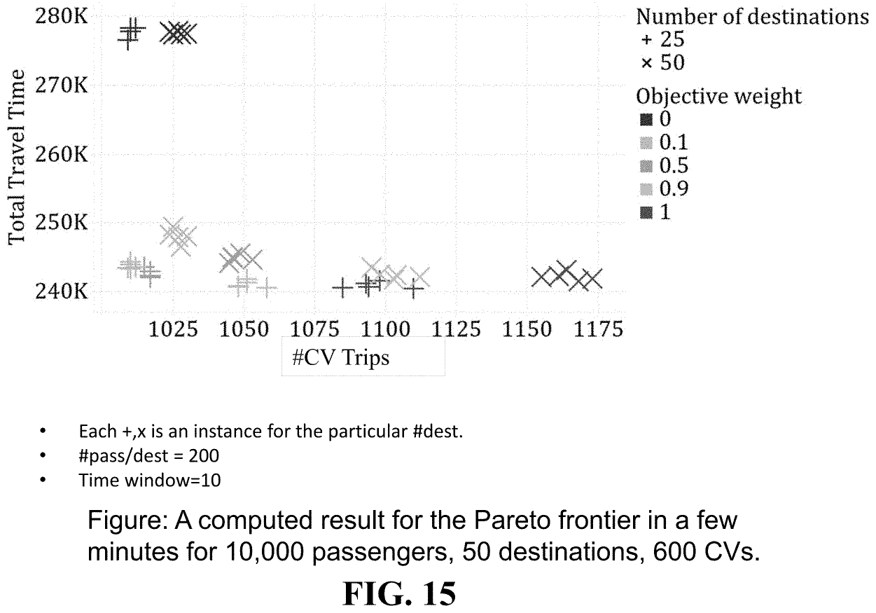

FIG. 15 is a computed result for the Pareto frontier in a few minutes for 10,000 passengers, 50 destinations, 600 CVs using the BP formulation, according to embodiments of the present disclosure. The pareto frontier shows that a small tradeoff in one of the objectives can result in big improvement in the other objective. This is important for the system operator as the entire curve can be produced in a matter of few minutes and an appropriate trade-off selected during the operation.

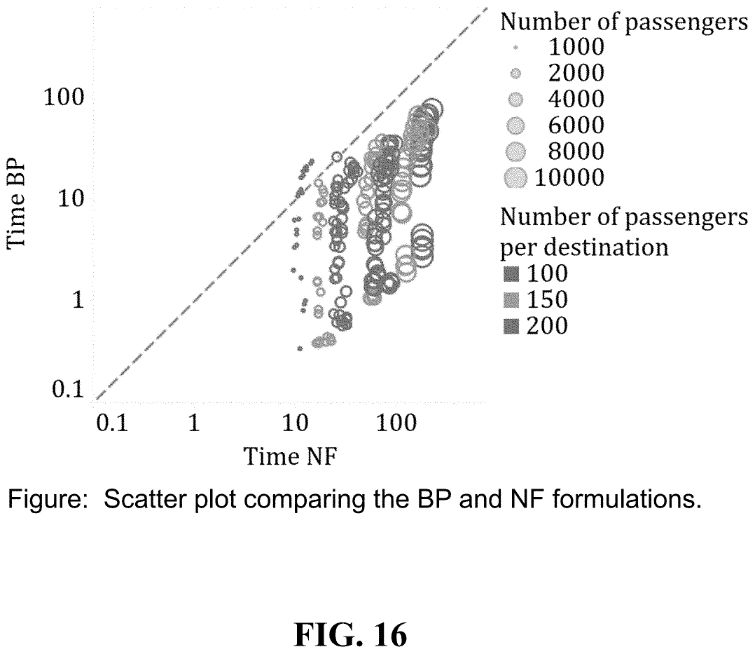

FIG. 16 is a scatter plot comparing the BP and NF formulations, according to embodiments of the present disclosure. The coordinates are the runtime of NF and the runtime of BP. The size of the dot correspond to n (increase in size as n increases) and the color of the dot corresponds to the ratio of the number of passengers to the number of destinations (i.e., the average number of passengers per destination). This plot more readily reveals the advantage of BP in only a few, small, instances is the runtime of NF lower than that of BP.

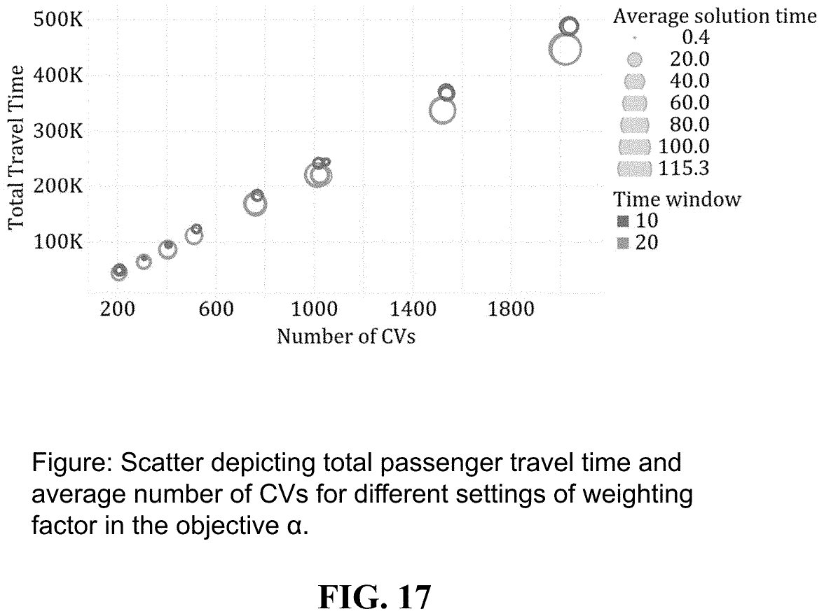

FIG. 17 is a scatter depicting total passenger travel time and an average number of CVs for different settings of weighting factor in the objective a. The coordinates of every dot corresponds to the number of CV trips and the total passenger travel time in the solutions obtained. The size of the circle corresponds to the average solution time over all instances tested. The instances are broken up by time window, colored blue for Tw=10 and orange for Tw=20. This plot show that the quality of the solutions obtained are only marginally different when we widen the time windows. Averaged overall instances, the number of CV trips is 888 and 877 and the total travel time is 213,239 and 198,406 Tw=10 and Tw=20, respectively. The represents a decrease in number of CV trips of 1.21% and a decrease in total travel time of 6.96%. The increase in solution time is much more substantial, increasing from 68.24 to 153.32 seconds, on average, a 123.21% increase. This indicates that allowing more exibility in arrival time constraints makes the problem significantly harder, but results in slightly better operational decisions. This therefore indicates that an operator might try to solve the problem with relatively large time windows, but then decrease this exibility should solutions need to be obtained is less computational time.

Accordingly, some embodiments of the present disclousre can reduce a power consumption of a computer (processor) and improve the functions of a computational system.

In some embodiments of the present disclosure, when the commuter vehicle assigning system is used or the executable program modules described above are installed in a computer system, the commuter vehicle assigning can be effectively and accurately performed with less time and less computing power, thus the use of a commuter vehicle assigning method or system described in the present disclosure can reduce central processing unit usage and power consumption.

The above-described embodiments of the present disclosure can be implemented in any of numerous ways. For example, the embodiments may be implemented using hardware, software or a combination thereof. Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements

Although the present disclosure has been described with reference to certain preferred embodiments, it is to be understood that various other adaptations and modifications can be made within the spirit and scope of the present disclosure. Therefore, it is the aspect of the append claims to cover all such variations and modifications as come within the true spirit and scope of the present disclosure.

What is claimed is:

1. A system for assigning commuter vehicles (CVs) in a multi-modal transportation network having the CVs and fixed schedule vehicles to passengers, comprising:
an interface to receive itinerary requests from the passengers, wherein the itinerary requests include initial locations, target locations, departure times from the initial locations, and arrival time windows including deadlines at the target locations;
a memory to store computer executable programs including a grouping program, a route-search program, an operation route map program of the CVs, and a commuter assigning program; and
a processor to perform the computer executable programs in connection with the memory, wherein the grouping program comprises:
formulating an optimization problem to determine groups of passengers based on the target locations of the passengers and to determine start times on the fixed schedule vehicles and CVs for the passengers;
solving the optimization problem to generate a solution defining the groups of passengers and the start times on the fixed schedule vehicles and CVs for the passengers;
storing the solution obtained from solving the optimization problem in the memory, wherein the formulating, solving and storing are repeated for obtaining solutions for a set of weighting factors and combinations of total travel times of the passengers and a number of groups;
choosing a solution among the solutions obtained for linear combinations of the total travel times of the passengers and the number of groups;
assigning the CVs to the groups and routes for the CVs by performing the commuter assigning program;
generating assignment information of the assigned CVs among the CVs based on the chosen solution, wherein the assignment information includes the assigned CVs to the groups, the routes assigned to the CVs, intermediate locations and start times of the assigned CVs from the intermediate locations; and
transmitting the assignment information to the assigned CVs via the interface.

2. The system of claim 1, wherein the optimization problem is formulated to minimize a linear combination of a sum of the total travel times of all the passengers and the number of the groups, wherein the combination is performed using a weighting factor.

3. The system of claim 1, wherein the optimization problem includes constraints to ensure that passengers reach destination within the arrival time windows of the passengers and ensure that a number of passengers in each of the groups is smaller than a number of seats in the CVs, wherein the route-search and operation route map programs provide respective travel times for the CVs, wherein the constraints ensure that a number of CVs operating simultaneously is smaller than a total number of available CVs stored in the memory.

4. The system of claim 1, wherein the groups are assigned the routes and the intermediate locations by performing the route-search program using the operation route map program of the CVs, wherein the routes respectively reach the target locations of the groups from the intermediate locations, wherein the groups are assigned the start times at the intermediate locations to allow the passengers of the groups to switch from the fixed schedule vehicles to the CVs at the intermediate locations and reach the target locations within the arrival time windows.

5. The system of claim 1, wherein the grouping program is performed by constructing and computing decision diagrams (DDs) for each of the target locations of the passengers, wherein each of the DDs is constructed based on a number of the passengers traveling to a common target location, the arrival time windows of the passengers and a seat capacity of each of the CVs.

6. The system of claim 1, wherein the grouping program sorts the passengers in ascending order of deadlines in the arrival time windows.

7. The system of claim 1, wherein when an itinerary request of a passenger includes a preferred option that indicates a minimum total cost to be paid by the passenger, the passenger is assigned to a group that satisfies another constrain for minimizing a sum of costs of a scheduled vehicle and an assigned CV.

8. The system of claim 1, wherein the operation statuses of the CVs are monitored and updated by receiving a status information from each of the CVs via an information interface, wherein the operation statuses include locations of the CVs and a number of available seats of each of the CVs, wherein the updated operation statuses are stored into the memory.

9. The system of claim 1, wherein the memory stores fares and time tables of the fixed schedule vehicles that stop at the intermediate locations.

10. The system of claim 1, further comprises transmitting, via the interface, an itinerary to each of the passengers with a departure time of a fixed schedule vehicle accessible from an initial location, one of the intermediate locations and one of the assigned CVs so that each of the passengers reaches a corresponding intermediate location prior to a start time of the one of the assigned CVs.

11. The system of claim 1, wherein the optimization problem is formulated to minimize a linear combination of the total travel times and an energy to be consumed by the CVs, a total fare to be paid by each of the passengers, a linear combination of a total travel time and the total fare or a linear combination of the total travel time and an energy to be consumed by the fixed schedule vehicles.

12. The system of claim 10, wherein the itinerary includes a total fare to be paid by each of the passengers, the optimization problem is solved to satisfy the total fare as one of constraints.

13. The system of claim 1, wherein the steps of grouping, assigning, ensuring and evaluating are repeated until a predetermined time limit is reached on the processor.

14. The system of claim 1, wherein the interface receives information on traffic conditions including traffic jams, traffic accidents and constructions on the operation route map program via the network and the route-search program searches the routes of the groups so as to avoid the traffic conditions.

15. The system of claim 1, wherein the commuter assigning program solves the optimization problem based on one of constraints of the total travel times of the passengers, an energy used by the assigned CVs in transporting the passengers and a linear combination of the total travel times and the energy used in transporting the passengers.

16. The system of claim 1, wherein the passengers assigned to an identical group share an identical CV.

17. The system of claim 1, wherein each of the passengers has a total travel time.

18. The system of claim 1, wherein the system transmits each passenger information as to how much a fare of a fixed scheduled vehicle is reduced if a passenger chooses an environment-friendly travel schedule.
